(19) United States
(12) Patent Application Publication
(10) Pub. No.: US 2024/0430602 A1
(43) Pub. Date: Dec. 26, 2024

(54) Outward Floating Earphone and Intelligent Voice Interaction Method Thereof

(71) Applicant: Yuanhao Liu, Shenzhen (CN)

(72) Inventor: Yuanhao Liu, Shenzhen (CN)

(21) Appl. No.: 18/241,905

(22) Filed: Sep. 4, 2023

(30) Foreign Application Priority Data
Jun. 20, 2023 (CN) 2023107347021

(51) Int. Cl. H04R 1/10; G10L 15/22

(52) U.S. Cl. CPC H04R 1/1016; G10L 15/22; H04R 1/1041; H04R 1/105; H04R 1/1066; G10L 2015/223; G10L 2015/225

(57) ABSTRACT

An outward floating earphone includes an ear-floating acoustic portion for being placed in the cavum conchae of a user's ear to produce sound effect, a connecting portion, and a positioning portion. The ear-floating acoustic portion and the positioning portion are respectively connected to two ends of the connecting portion. The connecting portion is bent and extended to make the positioning portion be suitable for being located at the back of the user's ear, so as to make the ear-floating acoustic portion suitable for floating at a front end of the cavum conchae through the fixing effect of the positioning portion and the connecting portion.

### CROSS REFERENCE OF RELATED APPLICATION

This application is a non-provisional application that claims priority under 35 U.S.C. § 119 to China application number CN202310734702.1, filing date Jun. 20, 2023, wherein the entire content of which is expressly incorporated herein by reference.

### BACKGROUND OF THE PRESENT INVENTION

### Field of Invention

The present invention relates to an earphone, and more particularly to an outward floating earphone and intelligent voice interaction method thereof.

### Description of Related Arts

Conventional earphones are usually worn in various ways, such as headwear, in-ear, neck-mounted, and rear-mounted. However, conventional earphones still have the following shortcomings that need improvement: conventional wired earphones have certain limitations during use and are not easy to store. The manufacturing cost of conventional earphones is high, and there are so many manufacturing steps. Clamping the head during the wearing process causes discomfort for users and makes it difficult to dissipate heat. Wearing conventional neck-mounted earphones can be cumbersome, prone to loss and unhygienic. Conventional rear-mounted earphones are prone to competition for wearing space with the eyeglass frames that users have already worn during the wearing process, are not easy to store, and output poor quality sound. Conventional in-ear earphones can cause closure of the user's cavum conchae during wearing. Prolonged time of wearing of conventional in-ear earphones can easily cause hearing damage and the growth of bacteria in the user's cavum conchae, resulting in unhygienic conditions. Additionally, prolonged time pf wearing of conventional in-ear earphones can cause discomfort in the user's ears, causing swelling, pain, discomfort, difficulty in fixation, fear of loss, and lack of high fidelity. In addition, conventional earphones are not suitable for long-term wear, so they only have the function of playing sound effects and cannot provide more intelligent interaction functions.

### SUMMARY OF THE PRESENT INVENTION

The invention is advantageous in that it provides an outward floating earphone, wherein the outward floating earphone is worn in an open manner and is held in the user's cavum conchae, providing a painless feeling after being worn by the user, and is suitable for long-term wearing.

Another advantage of the present invention is to provide an outward floating earphone, wherein the outward floating earphone is not directly inserted into the users' external ear canal and closes the external ear canal, does not cause compression on the user's ear canal, avoids ear membrane damage or hearing loss during use, and can allow the user to hear external environment noise, so as to avoid safety hazards.

Another advantage of the present invention is to provide an outward floating earphone, wherein the outward floating earphone is suitable for being kept in the user's cavum conchae, located in a position suitable for outputting sound effects, and does not affect the listening effect or cause leakage in such a manner that people adjacent to it will not hear the sound of the earphone, so that the outward floating earphone does not affect others, and privacy will not be eavesdropped.

Another advantage of the present invention is to provide an outward floating earphone, wherein the outward floating earphone has a certain decorative effect at the user's ear while being worn, and functions as an earring during use as an earphone.

Another advantage of the present invention is to provide an outward floating earphone, wherein the outward floating earphone can be set with decorations on the outer surface of the earphone using processes such as diamond inlaying, patterning, carving, or detachable assembling, so that the earphone has additional decorative effect.

Another advantage of the present invention is to provide an outward floating earphone, wherein the outward floating earphone can be produced through different manufacturing processes in different shapes for customized production, so that the outward floating earphone has a high degree of user preferrence, a large market audience, and is easy to be promoted.

Another advantage of the present invention is to provide an outward floating earphone, wherein the outward floating earphone is made of rigid materials or materials with high ductility, so that the relative position between two end portions has strong flexibility, and can be suitable to users of different age groups, so as to be suitable for being worn on and fixed to the ears of different users, so that it is not easy to be lost, and can be suitable for a larger user group.

Another advantage of the present invention is to provide an outward floating earphone, wherein compared to conventional earphones which centralize sound effect output units, the outward floating earphone disperses the distribution of the components, wherein in terms of manufacturing technology, the sound effect components located on the side of the user's cavum conchae while being worn can have a larger size, so as to enhance the sound output effect.

Another advantage of the invention is to provide an outward floating earphone, wherein the outward floating earphone can simultaneously function as a hearing aid, and can be applied to special groups of people, wherein the earphone and hearing aid are combined together, so as to provide both functions of helping the user to listen to others and answering and making calls, wherein the earphone can be switched freely, so as to avoid the trouble caused by replacing earphones and hearing aid devices and facilitate the wearing of people of poor hearing.

Another advantage of the present invention is to provide an outward floating earphone, wherein the outward floating earphone has a wire slot, wherein when the wires run from one side to the other, different wire colors are displayed by exposing the wires in the wire slot, so as to provide a certain decorative function.

Another advantage of the present invention is to provide an outward floating earphone, wherein the outward floating earphone is manufactured using a split distribution configuration with a power supply unit located on the rear ear side, so that the outward floating earphone can be designed with a larger battery life, so as to be suitable for wear and use for longer periods of time compared to conventional wireless earphones.

Another advantage of the present invention is to provide an outward floating earphone, wherein the outward floating earphone has intelligent interaction functions, as well as has voice reminding function and wake-up function, and can function as an access port for the Internet of Things, so as to be integrated with artificial intelligence to obtain instructions in real-time through voice commands, recognize and process collected information, feedback operations based on semantic results, and finally perform corresponding work such as measuring body temperature and heart rate.

Another advantage of the present invention is to provide an intelligent voice interaction method, wherein an earphone equipped with an intelligent interaction module can be worn for a long time and can be worn in an open wearing manner tby being hung in the user's cavum conchae to provide sound effect output to the user, and has the function of intelligent voice interaction.

Another advantage of the present invention is to provide an intelligent voice interaction method, wherein an implementation method of an outward floating earphone equipped with an intelligent interaction module can interact with artificial intelligence (AI), making it easy to be applied in spatialized intelligent scenes.

Another advantage of the present invention is to provide an intelligent voice interaction method, which an outward floating earphone equipped with an intelligent interaction module have the function of improving mood, wherein based on real-time user wearing scenes, music can be preset and played by monitoring user status, so as to adjust and improve user mood.

According to an aspect of the present invention, the present invention provides an outward floating earphone comprising: an ear-floating acoustic portion for being placed in a cavum conchae of a user's ear to produce sound effect; a connecting portion; and a positioning portion, wherein said ear-floating acoustic portion and said positioning portion are respectively connected to two opposite ends of said connecting portion, wherein said connecting portion is bent and extended to make said positioning portion be suitable for being located at a back of the user's ear, so as to make said ear-floating acoustic portion suitable for floating at a front end of the cavum conchae through fixing effect of said positioning portion and said connecting portion.

According to an embodiment of the present invention, when said outward floating earphone is in a wearing state, said connecting portion is clamped on the user's helix, and said positioning portion is located on a rear side of the user's helix.

According to an embodiment of the present invention when said outward floating earphone is in a wearing state, said connecting portion is clamped on the user's earlobe, and said positioning portion is located on a back side of the user's earlobe.

According to an embodiment of the present invention, when said outward floating earphone is in a wearing state, said connecting portion is clamped on the user's earlobe, and said positioning portion is biasing against an ear root at the back of the user's ear.

According to an embodiment of the present invention, the outward floating earphone further comprises a hook holding portion connected to said positioning portion for hooking to the user's ear, so that said outward floating earphone serves as an ornament when not in operation for producing the sound effect.

According to an embodiment of the present invention, the outward floating earphone further comprises at least one external decoration unit which is arranged on at least a part of surfaces of said ear-floating acoustic portion, said positioning portion, and said connecting portion.

According to an embodiment of the present invention, the outward floating earphone further comprises an earring unit, wherein said earring unit is a pendant arranged at one of said connecting portion and said positioning portion.

According to an embodiment of the present invention, the outward floating earphone further comprises an intelligent assistant disposed inside said outward floating earphone, wherein said intelligent assistant comprises an input algorithm for receiving information; a processing algorithm for processing information from a network; and an output algorithm for outputting information to control the outward floating earphone to produce the sound effect to the user.

According to an embodiment of the present invention, said input algorithm comprises an sensing assembly and a voice inquiry module, wherein said sensing assembly monitors user data parameters and actively inquries the user for the user's need through said voice inquiry module.

According to an embodiment of the present invention, said input algorithm comprises a voice receiving module adapted to passively receive information transmitted from a user to said outward floating earphone.

According to an embodiment of the present invention, said processing algorithm comprises a processing module, a search module, a comparison module, and a confirmation module, wherein said processing module, said search module, said comparison module, and said confirmation module are arranged to operate in sequence, so as to filter and process the information provided by said input algorithm online.

According to an embodiment of the present invention, said output algorithm comprises a transmission module adapted to transmit processed information to an external intelligent device.

According to an embodiment of the present invention, said output algorithm comprises a sound output module adapted to transmit processed information to a user through said outward floating earphone.

According to another aspect of the present invention, the present invention provides a method of implementing intelligent voice interaction by an earphone, comprising the following steps:
(A) incorporating an intelligent assistant into an earphone for intelligent interaction;
(B) receiving a voice command by a microphone unit;
(C) transmitting signals related to the voice command to said intelligent assistant; and
(D) providing feedback to a user in such a manner that said intelligent assistant controls said earphone to produce sound effect.

According to an embodiment of the present invention, said intelligent assistant accesses real-time information on the network and emits sound through said earphone to provide feedback to the user.

According to an embodiment of the present invention, said intelligent assistant searches for answer information corresponding to the voice command on the network and produces the sound effect through said earphone to provide feedback to the user.

According to an embodiment of the present invention, said intelligent assistant performs online shopping based on the corresponding voice command, and generate the sound effect through said earphone to feedback to the user.

According to an embodiment of the present invention, said intelligent assistant control said earphone to produce the sound effect related to multimedia information obtained from the network based on the corresponding voice command, so as to feedback to the user.

According to an embodiment of the present invention, said intelligent assistant makes phone calls, sends emails, provides peripheral travel suggestions to users, or controls operation of an intelligent device based on the corresponding voice command, wherein the intelligent device is a home or office device.

According to an embodiment of the present invention, said earphone is an outward floating earphone comprising: an ear-floating acoustic portion for being placed in a cavum conchae of a user's ear to produce sound effect; a connecting portion; and a positioning portion, wherein said ear-floating acoustic portion and said positioning portion are respectively connected to two opposite ends of said connecting portion, wherein said connecting portion is bent and extended to make said positioning portion be suitable for being located at a back of the user's ear, so as to make said ear-floating acoustic portion suitable for floating at a front end of the cavum conchae through fixing effect of said positioning portion and said connecting portion.

### BRIEF DESCRIPTION OF THE DRAWINGS

FIG. 1 is a perspective view of an outward floating earphone according to a first preferred embodiment of the present invention.

FIG. 2 is another perspective view of the outward floating earphone according to the above first preferred embodiment of the present invention.

FIG. 3 is an exploded perspective view of the outward floating earphone according to the above first preferred embodiment of the present invention.

FIG. 4 illustrates the wearing scene of the outward floating earphone according to the above first preferred embodiment of the present invention.

FIG. 5 illustrates an implementation method for forming an intelligent voice interaction device according to the above first preferred embodiment of the present invention.

FIG. 6 is a perspective view of an outward floating earphone according to a second preferred embodiment of the present invention.

FIG. 7 is another perspective view of the outward floating earphone according to the preferred embodiment of the present invention.

FIG. 8 is an exploded perspective view of the outward floating earphone according to the above second preferred embodiment of the present invention.

FIG. 9 illustrates a wearing scene of the outward floating earphone according to the above second preferred embodiment of the present invention.

FIG. 10 is a perspective view of an outward floating earphone according to a third preferred embodiment of the present invention.

FIG. 11 is another perspective view of the outward floating earphone according to the preferred embodiment of the present invention.

FIG. 12 is an exploded perspective view of the outward floating earphone according to the above third preferred embodiment of the present invention.

FIG. 13 illustrates an application scene of the outward floating earphone according to the above third preferred embodiment of the present invention.

FIG. 14 illustrates a usage scene of the outward floating earphone with an intelligent assistant according to the above third preferred embodiment of the present invention.

FIG. 15 is a perspective view of an outward floating earphone according to a fourth preferred embodiment of the present invention.

FIG. 16 is a perspective view of an outward floating earphone according to a fifth preferred embodiment of this aspect.

FIG. 17 is another perspective view of the outward floating earphone according to the above fifth preferred embodiment of the present invention.

FIG. 18 illustrates a wearing scene of the outward floating earphone according to the above fifth preferred embodiment of the present invention.

FIG. 19 is a perspective view of an outward floating earphone according to a sixth preferred embodiment of the present invention.

FIG. 20 is another perspective view of the outward floating earphone according to the above sixth preferred embodiment of the present invention.

FIG. 21 illustrates a wearing scene of the outward floating earphone according to the above sixth preferred embodiment of the present invention.

FIG. 22 is a perspective view of an outward floating earphone according to a seventh preferred embodiment of the present invention.

FIG. 23 is another perspective view of the outward floating earphone according to the above seventh preferred embodiment of the present invention.

FIG. 24 illustrates a wearing scene of the outward floating earphone according to the above seventh preferred embodiment of the present invention.

FIG. 25 is a perspective view of an outward floating earphone according to an eighth preferred embodiment of the present invention.

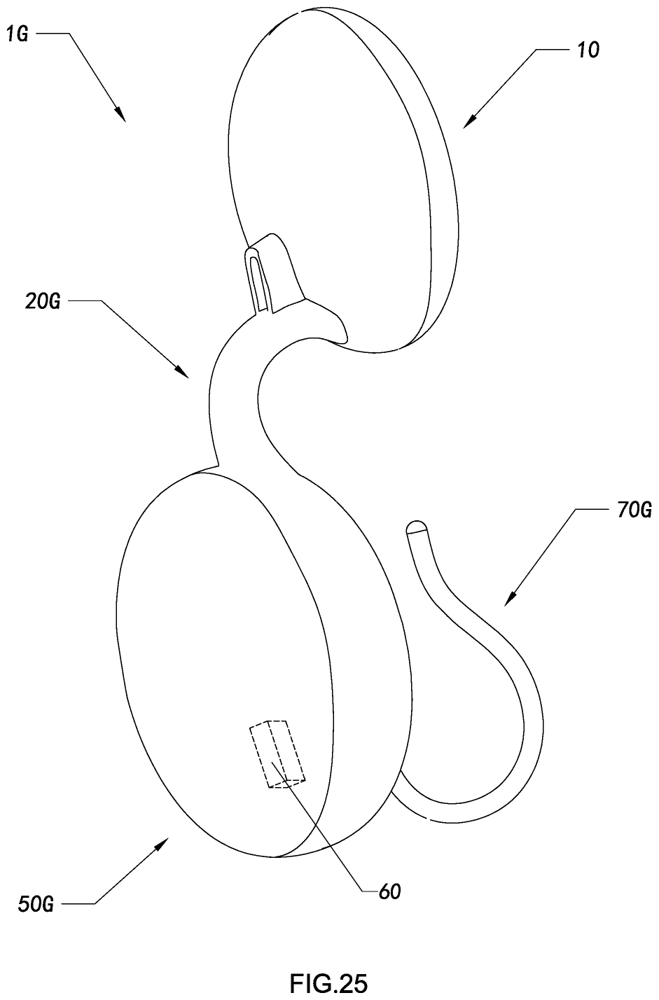

FIG. 26 is another perspective view of the outward floating earphone according to the above eighth preferred embodiment of the present invention.

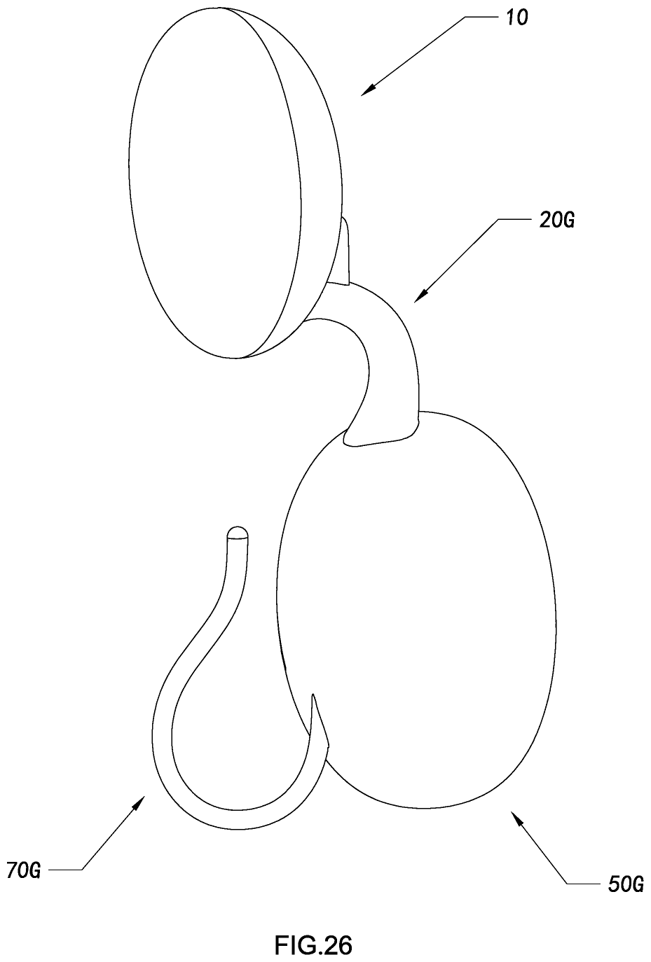

FIG. 27 illustrates a wearing scene of the outward floating earphone according to the above eighth preferred embodiment of the present invention.

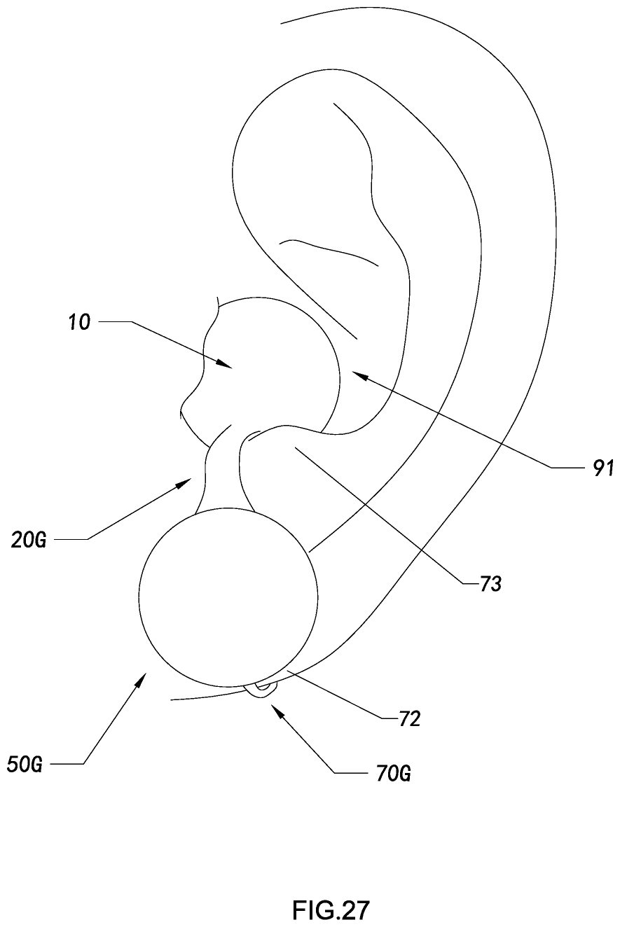

FIG. 28 illustrates a second wearing scene of the outward floating earphone according to the above eighth preferred embodiment of the present invention.

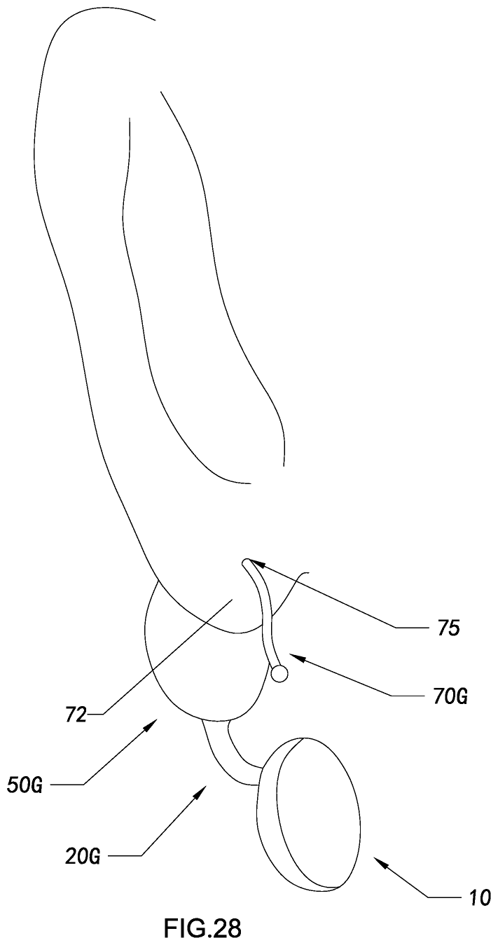

FIG. 29 illustrates a third wearing scene of the outward floating earphone according to the above eighth preferred embodiment of the present invention.

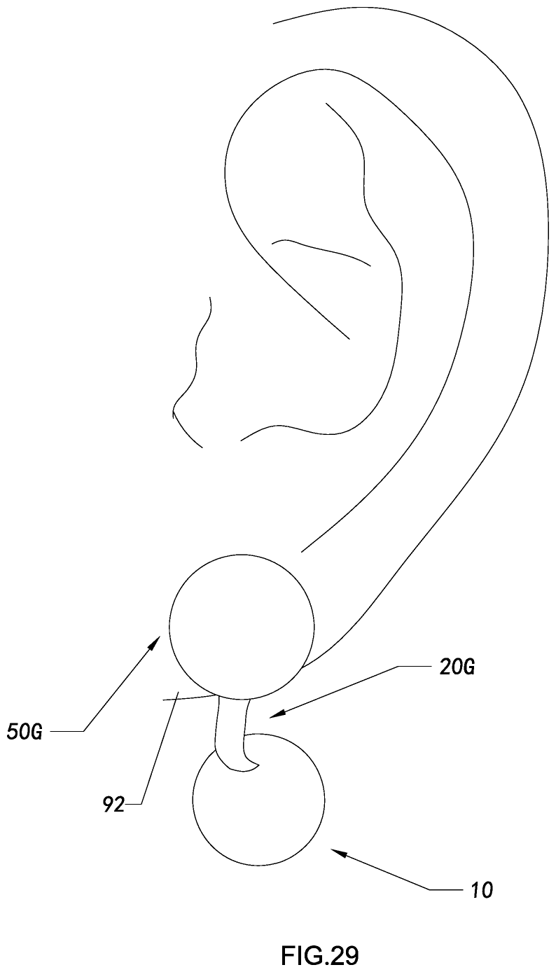

FIG. 30 a perspective view of an outward floating earphone according to a ninth preferred embodiment of the present invention.

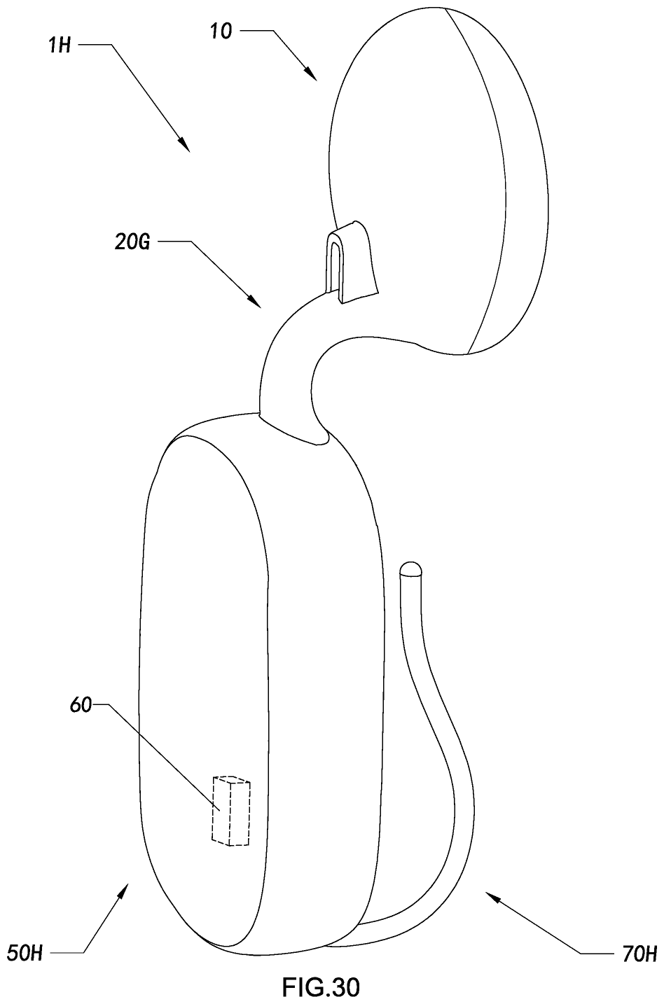

FIG. 31 is another perspective view of the outward floating earphone according to the above ninth preferred embodiment of the present invention.

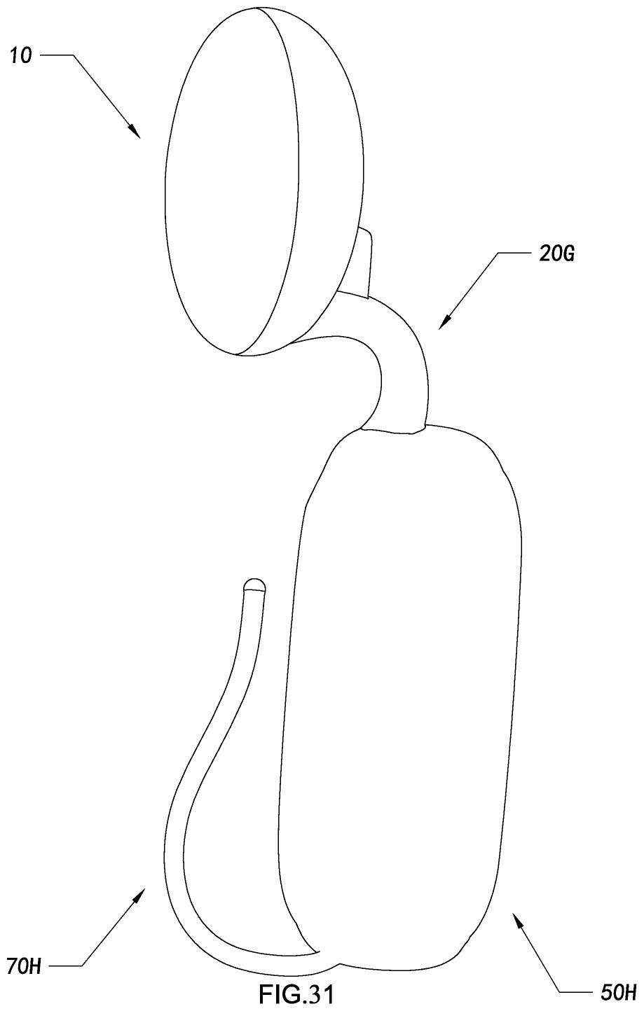

FIG. 32 illustrates a wearing scene of the outward floating earphone according to the above ninth preferred embodiment of the present invention.

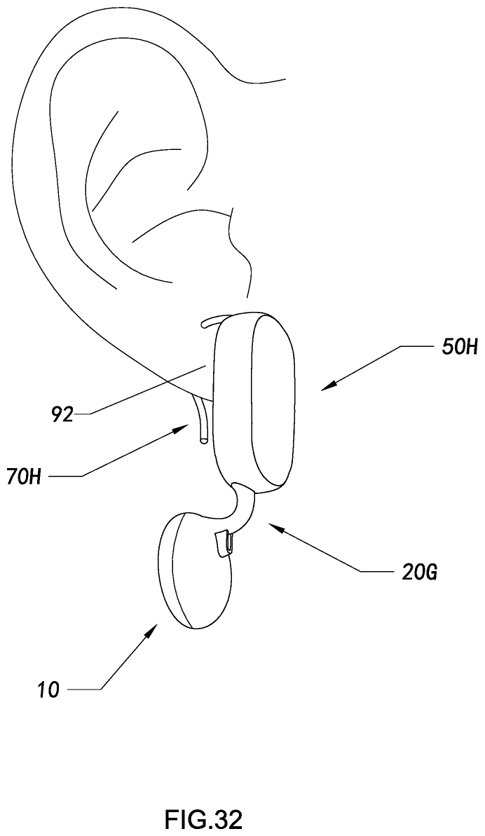

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. that indicate relations of directions or positions are based on the relations of directions or positions shown in the appended drawings, which are only to facilitate descriptions of the present invention and to simplify the descriptions, rather than to indicate or imply that the referred device or element is limited to the specific direction or to be operated or configured in the specific direction. Therefore, the above-mentioned terminologies shall not be interpreted as confine to the present invention.

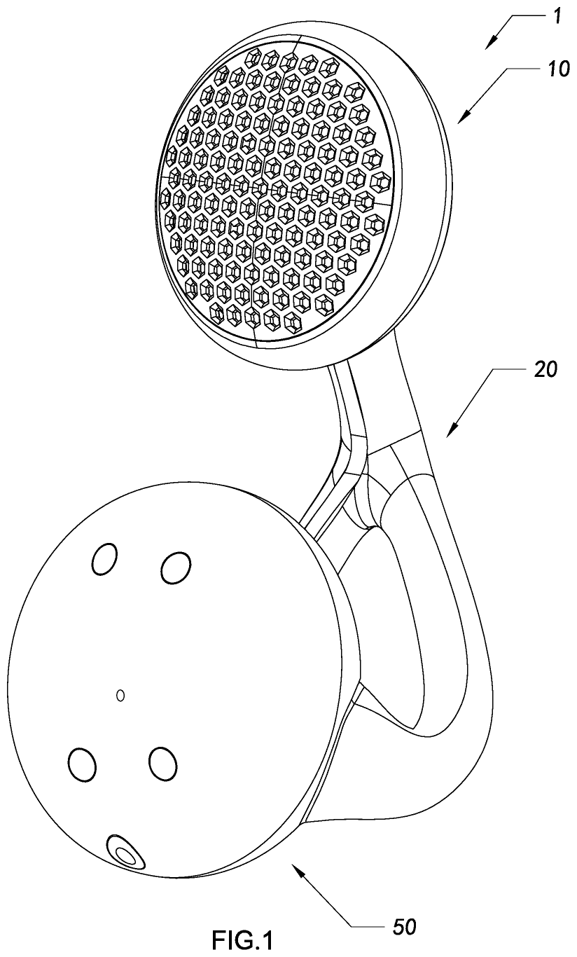

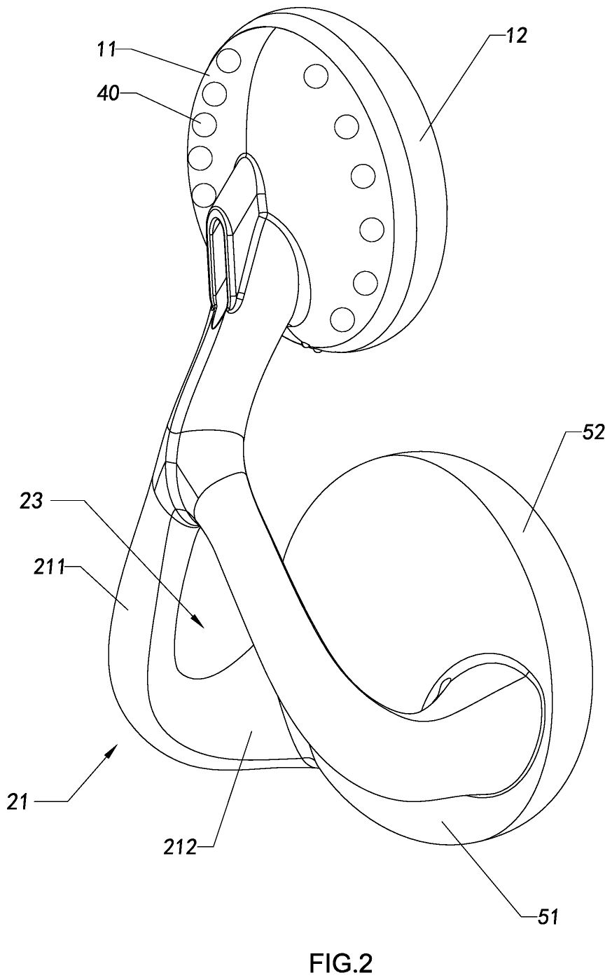

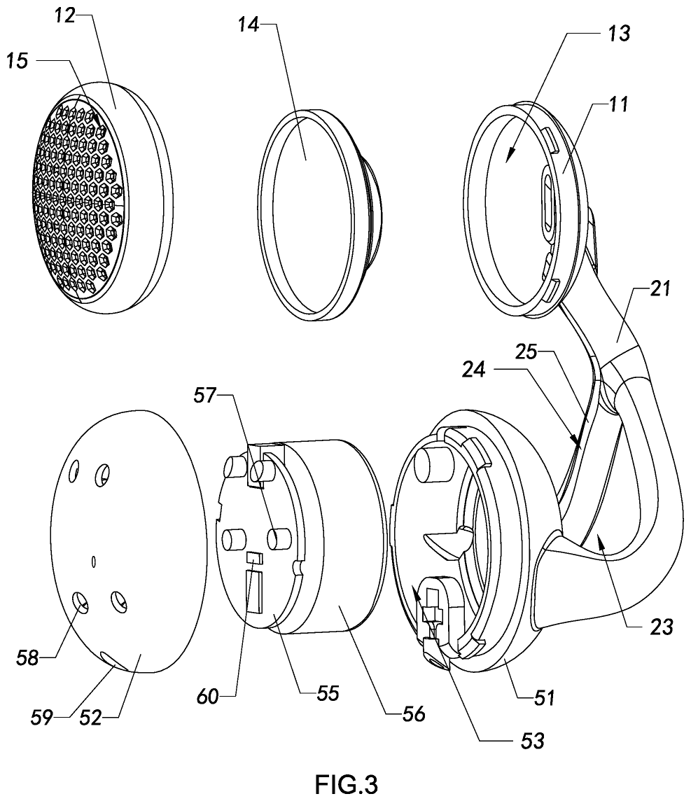

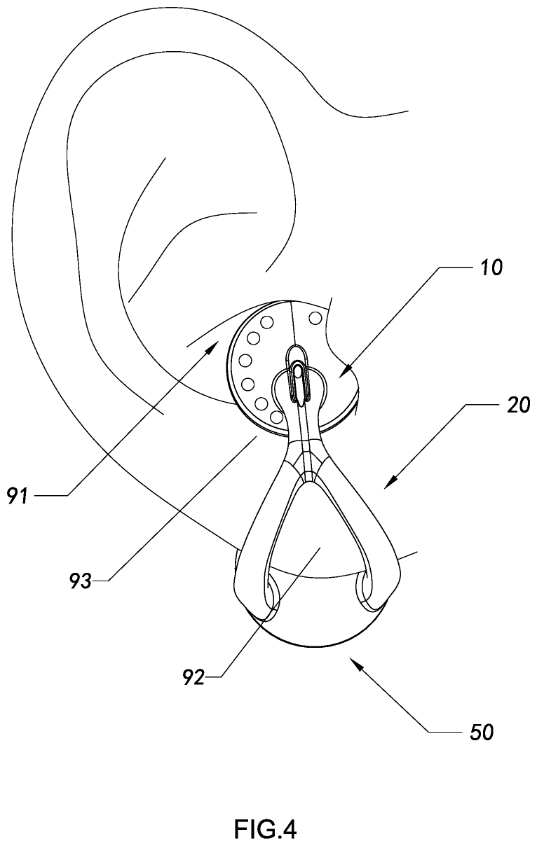

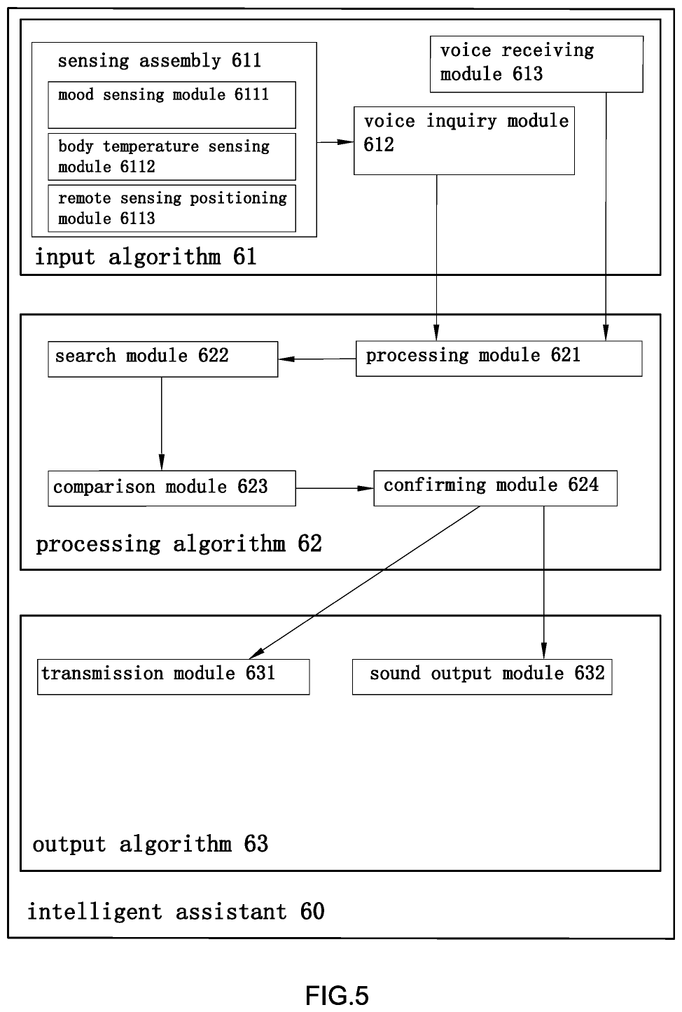

Referring to FIGS. 1 to 5, an outward floating earphone 1 according to a first preferred embodiment of the present invention is illustrated. The outward floating earphone 1 is suitable for being worn on a user's ear and outputting sound into the user's external auditory canal through electroacoustic conversion.

For ease of explanation, when the outward floating earphone 1 is worn by a user, the side facing the user's earlobe 92 is defined as front, and vice versa, is defined as rear. The direction where the user's cavum conchae 91 is located above the user's earlobe 92 is defined as up, and vice versa, defined as down.

The outward floating earphone 1 comprises an ear-floating acoustic portion 10, a connecting portion 20, and a positioning portion 50. The ear-floating acoustic portion 10, the connecting portion 20, and the positioning portion 50 are connected to each other. One end of the connecting portion 20 is connected to the ear-floating acoustic portion 10, and the other end is connected to the positioning portion 50. When the outward floating earphone 1 is in a wearing state, the ear-floating acoustic portion 10 is located inside the user's cavum conchae 91, the connecting portion 20 clamps the front and rear sides of the ear, and the positioning portion 50 is attached to the back of the user's ear. Therefore, through the fixing function of the connecting portion 20 and the positioning portion 50, the ear-floating acoustic portion 10 is attached to a position corresponding to an opening of the outer ear canal and located at the front end of the cavum conchae 91, without completely being plugged deeply into outer ear canal to seal off the outer ear canal.

For example, according to the above first preferred embodiment, the connecting portion 20 is wound around the user's earlobe 92 extending from the front face of the user's earlobe 92 to the rear face of the earlobe 92, and the positioning portion 50 is located on the rear face of the user's earlobe 92. The ear-floating acoustic portion 10 is located above the positioning portion 50 and is connected to each other through the connecting portion 20. The connecting portion 20 holds the user's earlobe 92 to adapt to different user wearing needs.

The ear-floating acoustic portion 10 has the function of outputting sound effects. The connecting portion 20 has the function of connecting and fixing. The positioning portion 50 is also equipped with other electronic components to have additional functions, such as power supply, AI intelligent interaction, etc. Compared to conventional earphone, the ear-floating acoustic portion 10 of the outward floating earphone 1 is suspended in the user's cavum conchae 91 and adjacent to the antitragus 93, and the connecting portion 20 and the positioning portion 50 are clamped on the user's ear lobe 92 to achieve the positioning and fixation of the outward floating earphone 1 and make the ear-floating acoustic portion 10 tend to press outward against the antitragus 93, thus not completely seal off the user's external auditory canal, so that a closed cavity is not formed between the eardrum and the ear-floating acoustic portion 10 of the ear. Due to avoiding the wearing manner of entering deeply into the ear, during the long-term wearing of the earphone, it avoids the damage to the eardrum of the user's ear caused by prolonged wearing which can cause damage to the user's hearing.

When the outward floating earphone 1 is in the wearing state, the ear-floating acoustic portion 10 is located in the user's cavum conchae 91. Compared to some current conventional earphones, the hanging position of the ear-floating acoustic portion 10 is appropriate, so as to protect the user's privacy and not disturb others cause by sound leakage. It can also maintain communication between the ear canal and the outside world, allowing the user to hear environment noise and avoid safety hazards.

It is worth mentioning that the connecting portion 20 can be made of rigid material or have a certain degree of ductility and bending. According to the above first embodiment, the connecting portion 20 plays a role in clamping the user's earlobe 92 during being worn. While the outward floating earphone 1 being worn, the acoustic portion 10 of the floating ear is suspended in the user's cavum conchae 91 and fixed through the auxiliary clamping of the connecting portion 20, ultimately fix the pendant type earphone on the user's ear to avoid loss caused by detachment. And subsequently, the positioning portion 50 can be moved away from the back of the user's earlobe 92 due to the extensibility of the connecting portion 20, and the outward floating earphone 1 can be easily removed.

Compared to conventional earphones that centralize various functions, the outward floating earphone 1 separates the ear-floating acoustic portion 10 and the positioning portion 50 from each other, so as to achieve that the ear-floating acoustic portion 10 located in the user's cavum conchae 91 can be configured with larger sized sound effects components, maximizing the sound output and providing users with a greater user experience. Moreover, the separation of the positioning portion 50 avoids the centralized implementation of corresponding functions. While the earphone 1 is worn, the positioning portion 50 is located on the back of the user's earlobe 92 and is not limited by the spatial size of the user's cavum conchae 91. In terms of manufacturing process, compared to conventional earphones, the positioning portion 50 can be improved with a larger battery capacity to obtain a longer battery life.

Furthermore, the outward floating earphone 1 comprises an external decoration unit 40. According to this first preferred embodiment, the exterior decoration unit 40 is located on the ear-floating acoustic portion 10. In detail, the exterior decoration unit 40 is arranged on the front surface of the ear-floating acoustic portion 10. According to this first preferred embodiment, the exterior decoration unit 40 is embodied as an ornament such as a diamond. According to another embodiment, the exterior unit 40 may be provided on the connecting portion 20 or the positioning portion 50. Therefore, the position setting of the exterior decoration unit 40 is not limited in the present invention.

The exterior decoration unit 40 can cooperate with the plasticity of the connecting portion 20 to achieve decorative effects on the outward floating earphone 1. In other words, the exterior decoration unit 40 and the connecting portion 20 jointly achieve the decorative purpose of the outward floating earphone 1. The exterior decoration unit 40 and the connecting portion 20 provide a certain degree of aesthetics.

The ear-floating acoustic portion 10 comprises a first chamber body 11, a first cover body 12, and has an inner cavity 13. The first chamber body 11 is integrally connected to the connecting portion 20. The first cover body 12 is installed on the rear end of the first chamber body 11. In terms of manufacturing process, the first chamber body 11 is detachably connected to the first cover body 12. The material of the first chamber body 11 is the same as that of the connecting portion 20.

The materials of the first cover body 12 and the first chamber body 11 can be different from each other. When the first cover body 12 is installed on the first chamber body 11, the inner cavity 13 is formed between the first cover body 12 and the first chamber body 11. The inner cavity 13 is suitable for providing installation space for radio functional components.

Furthermore, the material of the first chamber body 11 is preferably a ductile material such as copper according to this first preferred embodiment. The material of the first chamber body 11 can be silver, stainless steel, precious metals, such as K-gold, pure gold, etc. The materials also can be ABS, PP, PC, rubber, silicone, etc. Materials can be elastic or rigid. Therefore, the material of the first chamber body 11 is not limited in the present invention. According to this first preferred embodiment, the exterior decoration unit 40 is arranged on the first chamber body 11. When the outward floating earphone 1 is in the wearing state, the first chamber body 11 is exposed at the front side of the user, and the exterior decoration unit 40 is exposed at the front side of the user, adding a certain degree of decoration.

The material of the first cover body 12 is different from the material of the first chamber body 11. When the outward floating earphone 1 is in the wearing state, the first cover body 12 is facing the user's ear canal. The first cover body 12 is made of a material that does not block and prohibit electroacoustic conversion, thus, the first cover body 12 does not affect the output of sound effects.

The ear-floating acoustic portion 10 comprises a speaker 14. The speaker 14 is suitable for providing electroacoustic conversion and expanding and outputting the converted sound source. In other words, the outward floating earphone 1 outputs the audio sound to the user through the speaker 14. The speaker 14 is suitable for installation in the inner cavity 13. In other words, the speaker 14 is installed between the first chamber body 11 and the first cover body 12. When the outward floating earphone 1 is in the wearing state, the speaker 14 faces the user's ear canal and outputs sound to the user's ear canal through the first cover body 12.

The ear-floating acoustic portion 10 has a plurality of holes 15. The holes 15 are arranged on the first cover body 12. The holes 15 have a certain function of noise reduction. When the outward floating earphone 1 is in the wearing state, the holes 15 are facing the user's ear canal and the holes 15 penetrate through the first cover body 12. The speaker 14 is arranged to output sound to the user's external auditory canal through the holes 15, and balanced air pressure and noise reduction are achieved through the holes 15.

Correspondingly, the positioning portion 50 comprises a second chamber body 51, a second cover body 52, and has a functional cavity 53. The second chamber body 51 is integrally connected to the connecting portion 20, and the second cover body 52 is connected to the second chamber body 51. The materials of the second chamber body 51 and the second cover body 52 can be different. The functional cavity 53 is located between the second chamber body 51 and the second cover body 52. When the outward floating earphone 1 is in the wearing state, the second chamber body 51 is tightly attached to the rear face of the user's earlobe 92, and the second cover body 52 is behind the user's earlobe 92 and distal to the rear surface of the user's earlobe 92. The functional cavity 53 is suitable for receiving various functional components to achieve power supply, intelligent interaction, and other purposes.

The connecting portion 20 comprises a connecting body 21 which is integrally connected to the first chamber body 11 and the second chamber body 51. According to this first preferred embodiment, the connecting body 21 surrounds the user's earlobe 92 and extends from the user's front face to the rear face. The connecting body 21 comprises a front surface 211 and a rear surface 212. When the outward floating earphone 1 is worn, the front surface 211 is located on the front side of the user's earlobe 92, and the rear surface 212 is located on the back side of the user's earlobe 92. The connecting body 21, the first chamber body 11, and the second chamber body 51 are manufactured from the same material. According to this first preferred embodiment, the front surface 211 and the rear surface 212 are arranged in a “J” shape. The clamping space 23 is formed between the front surface 211 and the rear surface 212. The clamping space 23 is suitable for gripping the user's earlobe 92. In other words, when the outward floating earphone are worn, the front surface 211 is tightly attached to the front side of the user's earlobe 92, and the rear surface 212 is tightly attached to the back side of the user's earlobe 92. The user's earlobe 92 is always located within the clamping space 23.

According to this first preferred embodiment, the connecting portion 20 also has a wire slot 24, which is arranged on the rear surface 212. The wire slot 24 is connected to the inner cavity 13 and the functional cavity 53. The wire slot 24 has the function of guiding wires 25. In other words, the the inner cavity 13 and the functional cavity 53 are communicated through the wire slot 24. According to another embodiment, the wire slot 24 can be arranged on the front surface 211, and the wire slot 24 can be arranged inside the connecting body 21. In other words, wiring can be done internally. Therefore, the setting position of the wire slot 24 is not limited in the present invention.

According to this first preferred embodiment, the wire slot 24 is embodied to receive a transparent light strip which comprises a light emitting element anad a light fiber and is displayed externally in the wire slot 24 with strong decorative properties. Users can choose personalized transparent light strip colors according to their preferences to meet personalized fashion needs. Especially, when the outward floating earphone 1 is worn at night, the transparent light strip in the wire slot 24 can release different colored light sources, that is very cool.

Secondly, due to the extensibility of the connecting portion 20, the front surface 211 and the rear surface 212 can be bent apart from each other to change the spatial size of the clamping space 23. By changing the spatial size of the clamping space 23 to adapt to the size of the earlobe 92 of different users. And the fastening installation of the outward floating earphone 1 can be achieved by changing the real-time distance between the front and rear surfaces 211, 212 and the user's earlobe 92. Due to the extensibility of the front surface 211 and the rear surface 212, the range of applicability for different users is increased, and the possibility of falling off of the outward floating earphone 1 during wearing is avoided through the expansion of the extensibility.

According to this first preferred embodiment, the connecting body 21 is arranged in an inverted “Y” shape. When the outward floating earphone 1 is in the wearing state, the front surface 211 is close to and fits to the user's earlobe 92. Through the shape of the front surface 211, the decorative function of the outward floating earphone 1 is achieved by displaying forward, that is, the beauty of the outward floating earphone 1 is increased through the shape of the front surface 211. In terms of manufacturing technology, personal customization can be achieved by changing the different shapes of the connecting body 21, and the outward floating earphone 1 can be selected according to the user's preferences to achieve the effect of wearing and matching with a fashionable style. Therefore, the shape of the connecting body 21 is not limited in the present invention.

The positioning portion 50 comprises a power supply 56 and a circuit board 55, wherein the power supply 56 and the circuit board 55 are installed in the functional cavity 53. The power supply 56 provides the function of supplying electrical energy. The circuit board 55 provides the function of electrical signal processing. The circuit board 55 receives electrical signals and processes them on the speaker 14. The power supply 56 is electrically connected to the circuit board 55. The circuit board 55 is electrically connected to the speaker 14. The inner cavity 13 is communicated to the functional cavity 53 through the wire slot 24. The speaker 14 is electrically connected to the power supply 56 through the wires 25 in the wire slot 24. It can be understood that according to another embodiment, at least one of the power supply 56 and the circuit board 55 can also be set in the ear-floating acoustic portion 10.

The positioning portion 50 further comprises at least one charging terminal 59, which is arranged on the second cover body 52. The charging terminal 59 is suitable for providing an external charging connection of the power supply 56, In other words, the power supply 56 carries out charging through the charging terminal 59.

It is worth mentioning that the outward floating earphone 1 has the effect of improving the user's mood. When wearing the outward floating earphone 1, it is suitable for monitoring the user's heart rate and other mood values through light perception, and then playing preset music or imitating predetermined sound to adjust and improve the user's depressive mood. The circuit board 55 receives and processes electrical signals, transmits designated song electrical signal messages to the speaker 14, and ultimately plays and delivers sound effects to the user through the speaker 14. The circuit board 55 is suitable for electrically connecting to an external smart device. For parents, the condition of the child can be monitored through the outward floating earphone 1 electrically connected to the APP on the smart device, in order to make necessary interventions and avoid bad things from happening.

The speaker 14 is arranged in the inner cavity 13, and the circuit board 55 and the power supply 56 are arranged in the functional cavity 53. The outward floating earphone 1 separates functions of the sounding part 10 and the positioning portion 50 of the floating ear, and adopts a split structure, which has more advantages compared to conventional integrated earphones. For example, when the outward floating earphone 1 is in the wearing state, the ear-floating acoustic portion 10 is located in the user's cavum conchae 91, and the positioning portion 50 is located on the back of the user's earlobe 92. The ear-floating acoustic portion 10 occupies a relatively large space in the user's cavum conchae 91. In terms of manufacturing technology, for the ear-floating acoustic portion 10 close to the user's ear canal, it can be expanded to increase the total volume of the ear-floating acoustic portion 10. Thus changing the sound effect emitted by the speaker 14 and outputting a better sound effect.

In addition, the positioning portion 50 located on the back of the user's earlobe 92 only occupies the space on the back of the user's earlobe 92, making the positioning portion 50 occupy a larger space. In terms of manufacturing technology, the overall volume of the positioning portion 50 can be increased, so as to increase the size of the functional cavity 53. The spatial receiving space for the power supply 56 correspondingly increases. By changing the spatial size of the functional cavity 53 to adapt to the increased capacity of the power supply 56, the battery life of the outward floating earphone 1 is increased, and the service life of the outward floating earphone 1 is prolonged.

The positioning portion 50 further comprises a hearing aid unit 57, which is arranged on the circuit board 55. The hearing aid unit 57 is electrically connected to the power supply 56 and the circuit board 55. The outward floating earphone 1 can be freely switched between receiving and making calls and listening to people through the hearing aid unit 57. When a phone call comes in, it can be connected to the smart device through Bluetooth, and the outward floating earphone 1 switches to the function of making a call. The outward floating earphone 1 can achieve the function of hearing assistance through the hearing aid unit 57, which is convenient for users with poor hearing to wear, avoiding the trouble caused by alternately wearing the outward floating earphones 1 and hearing aids. Integrating the hearing aid function into the outward floating earphone 1 allows the outward floating earphone 1 to have a wider audience, a larger audience range, and a larger market share.

It is worth mentioning that according to this first preferred embodiment, the outward floating earphone 1 further comprises an intelligent assistant 60, which can comprise an intelligent interaction module or an artificial intelligence module, and the intelligent assistant 60 is disposed inside the positioning portion 50. Furthermore, the intelligent assistant 60 is arranged in the functional cavity 53, and the intelligent assistant 60 is arranged on the circuit board 55. The intelligent assistant 60 is electrically connected to the circuit board 55. The intelligent assistant 60 is suitable for providing functions such as voice reminder and wake-up, and serves as an access port for the Internet of Things. The intelligent assistant 60 is suitable for receiving and processing information, and transmitting the processed information to the circuit board 55, and ultimately to the speaker 14 for corresponding operation. According to this first preferred embodiment, the intelligent assistant 60 obtains instructions in real-time through human voices, recognizes and processes collected information, feeds back operations based on semantic results, and ultimately performs tasks such as measuring body temperature and heart rate. It can also be used for various intelligent interaction scenes in daily life and work, such as smart home control, smart office, smart calling, smart driving, and smart healthcare.

The positioning portion 50 further comprises a microphone unit 58. The microphone unit 58 is arranged on the second cover body 52, and is suitable for providing voice interaction functions. Furthermore, the microphone unit 58 is suitable for providing voice interaction functions of the intelligent assistant 60. It can be understood that the microphone unit 58 can be set at any position of the positioning portion 50, and the setting position of the microphone unit 58 is not limited in the present invention.

It is worth mentioning that the intelligent assistant 60 comprises an input algorithm 61, a processing algorithm 62, and an output algorithm 63. The input algorithm 61, the processing algorithm 62, and the output algorithm 63 together constitute the implementation method of the intelligent assistant 60. The user directly outputs the voice to the input algorithm 61 or the input algorithm 61 operates itself to generate interaction with the user. The processing algorithm 62 performs information filtering and comparison of advantages and disadvantages, and ultimately performs relevant operations through the output algorithm 63, which is fed back to the individual user or acts on the intelligent scene. In other words, the superior input source of the input algorithm 61 can be the intelligent assistant 60 or the user, which is filtered and compared through the processing algorithm 62, and the final filtered information is fed back to the user or the intelligent scene where the user is in.

Furthermore, the input algorithm 61 comprises a sensing assembly 611, a voice inquiry module 612, and a voice reception module 613. The sensing assembly 611 is suitable for receiving various scenes and data from users. In other words, the sensing assembly 611 can collect various types of data from users for subsequent interactive operations. The voice inquiry module 612 is suitable for providing the function of the intelligent assistant 60 to inquire with users. In other words, the intelligent assistant 60 is suitable for actively asking various needs of users through the voice inquiry module 612 for intelligent interaction. In detail, the voice inquiry module 612 is suitable for performing the operation of inquiring about user requirements through the microphone unit 58. The voice receiving module 613 is suitable for providing information processing functions that users request. In other words, the intelligent assistant 60 obtains voice output from the user through passive reception and performs subsequent information processing and interaction functions.

Therefore, the operation of the sensing assembly 611 is directed towards the voice inquiry module 612, and the intelligent assistant 60 performs active inquiry demand processing for users through the sensing assembly 611 and the voice inquiry module 612. In other words, the intelligent assistant 60 actively proposes relevant requirements for interaction with the user through the sensing assembly 611 and the voice inquiry module 612. The voice receiving module 613 is suitable for receiving active demand interactions from users. In other words, the intelligent assistant 60 passively receives user demand interactions through the voice receiving module 613.

The processing algorithm 62 comprises a processing module 621, a search module 622, a comparison module 623, and a confirming module 624. The processing module 621 is suitable for providing the function of information processing. The processing module 621 collects and processes the user interaction information actively acquired by the voice interrogation module 612 and the user interaction information passively acquired by the voice reception module 613. The search module 622 is suitable for providing online information search functions to search the information collected by the processing module 621 on various online platforms. The comparison module 623 is suitable for providing information filtering function, summarizing the information flow collected by the search module 622 and performing filtering through the comparison module 623, and selecting valuable information that matches user needs. The confirming module 624 is suitable for providing confirmation functions for information. The confirming module 624 may comprise further information comparison and process module to confirm the filtered information flow.

The output algorithm 63 comprises a transmission module 631 and a sound output module 632. The transmission module 631 is suitable for providing the transmission of the information flow confirmed by the confirming module 624 to relevant intelligent scenes and ultimately executing relevant intelligent interaction tasks. In other words, the intelligent assistant 60 is transmitted to the intelligent device through the transmission module 631 and performs related operations, forming a phenomenon where users are in an intelligent scene, achieving intelligent spatialization. The sound output module 632 is suitable for providing interactive execution of requirements, tasks, operations, etc. to users output by the intelligent assistant 60. In other words, the intelligent interaction through the intelligent assistant 60 is fed back to the user through the sound output module 632 in the form of voice output.

In addition, the sensing assembly 611 further comprise an emotional response module 6111, a body temperature sensing module 6112, and a remote sensing positioning module 6113. The sensing assembly 611 realizes the data acquisition of various functional requirement for users through the above modules, and the voice inquiry module 612 performs relevant demand inquiries for users to realize intelligent interaction.

For example, the mood sensing module 6111 has the function of collecting data on a user's mood value. The mood sensing module 6111 collects the user's mood data and asks through the voice inquiry module 612. For example, “The user's mood value is detected to be low, do you need to play a song that makes people feel happy?”. Subsequently, the information of online passion songs is filtered through the processing algorithm 62, and finally, sound effects are output to the user through the transmission module 631 to an external sound source device or its own speaker 14.

For example, the body temperature sensing module 6112 has the function of collecting user body temperature data. The body temperature sensing module 6112 collects user body temperature data and asks the user through the voice inquiry module 612. For example, “The user's body temperature is detected to be high, do you want to turn on the cooling fan?”. Subsequently, the processing algorithm 62 is used to grasp the parameters such as the fan output frequency or expected comfortable ambient temperature provided by the user, and ultimately output commands to the external fan device through the transmission module 631 to achieve intelligent interaction.

For example, the remote sensing positioning module 6113 has the function of collecting real-time geographic location of users. Through the collected positioning information, the voice inquiry module 612 asks the user. For example, “It is detected that the user is in position xx, and the current time is noon. Do you need to recommend a lunch place?” Subsequently, the processing algorithm 62 is used to conduct online nearby food searches on the internet, and limited by the “price range” information provided by the user, filtering and comparison are carried out, and the final confirmation is finished online to place an order, and the confirmation information is made known to the user through the sound output module 632.

Therefore, the intelligent assistant 60 can monitor and inquire about users in real-time through the sensing module 611, and actively recommend mutual command requirements to users, ultimately achieving intelligent interaction and feedback to users.

In addition, the intelligent assistant 60 is also suitable for performing intelligent interaction functions through passive reception. For example, the user is suitable to actively propose requirements to the intelligent assistant 60 through voice output, such as, “What is the score of two teams in today's football match?” The voice receiving module 613 receives user information, conducts online search of the network through the processing algorithm 62, and finally outputs results to the user through the sound output module 632. In the intelligent interaction provided by the intelligent assistant 60, it ensures that users can obtain the information flow they are interested in in real-time with practicality and accuracy.

In summary, the intelligent assistant 60 is suitable for obtaining user demand information through active or passive means, and ultimately transmitting information to external intelligent devices through the transmission module 631, performing intelligent scene interaction, or transmitting the information flow after information comparison on the network to the user through the microphone unit 58.

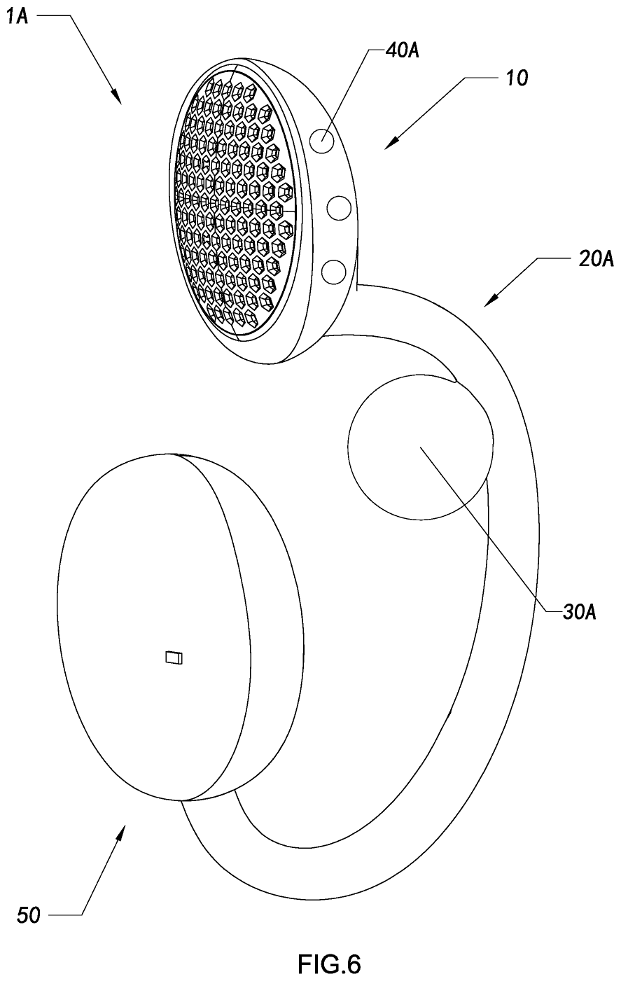

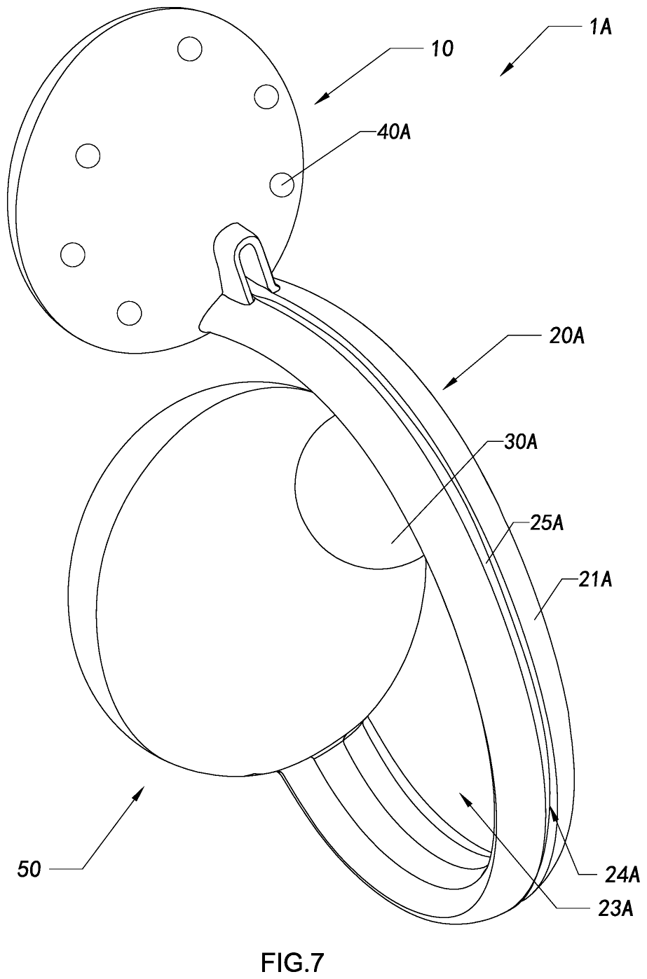

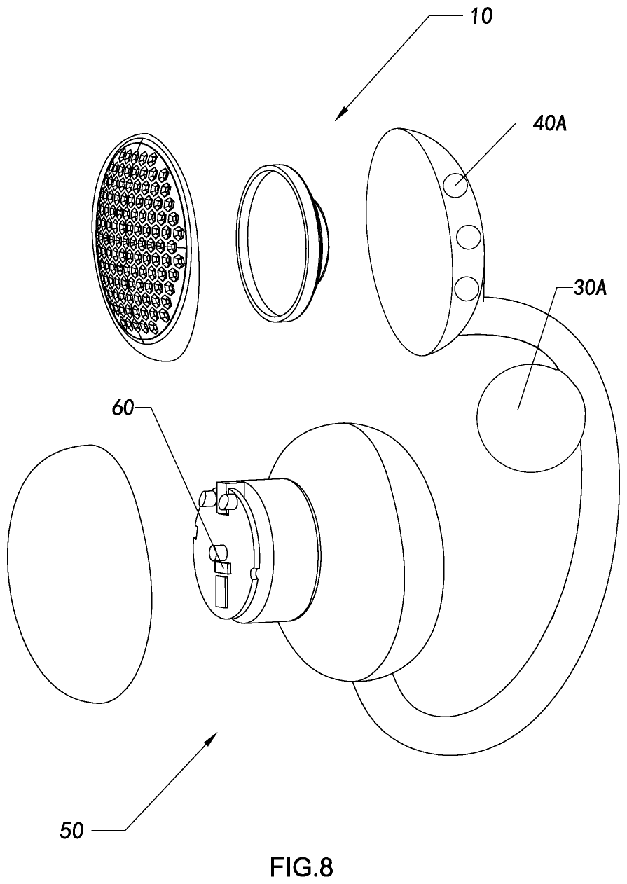

As shown in FIGS. 6 to 8, an outward floating earphone 1A according to a second preferred embodiment of the present invention is illustrated. Compared to the above first embodiments, the part which plays a connecting role is different.

The outward floating earphone 1A comprises an ear-floating acoustic portion 10, a connecting portion 20A, and a positioning portion 50. The ear-floating acoustic portion 10, the connecting portion 20A, and the positioning portion 50 are connected to each other. One end of the connecting portion 20A is connected to the ear-floating acoustic portion 10, and the other end is connected to the positioning portion 50. When the outward floating earphone 1A is worn, the ear-floating acoustic portion 10 is located in the user's cavum conchae 91, the connecting portion 20A is clamped on the user's earlobe 92 and extends from the front face of the user's earlobe 92 to the rear face of the earlobe 92, and the positioning portion 50 is located on the rear face of the user's earlobe 92. The ear-floating acoustic portion 10 has the function of outputting sound effects. The connecting portion 20A has the function of connecting and fixing. The positioning portion 50 can be equipped with built-in electronic components to have additional functions, such as power supply, AI intelligent interaction, etc.

The outward floating earphone 1A comprises an intelligent assistant 60, which is arranged within the positioning portion 50 to achieve AI intelligent interaction.

Compared with the above first preferred embodiment, a connection part 20A of the outward floating earphone 1A according to this second preferred embodiment is different, wherein the connection part 20A is set in a “J” shape. When the outward floating earphone 1A is in the wearing state, the connecting portion 20A is clamped on the user's earlobe 92.

The connecting portion 20A comprises a connecting body 21A, and has a clamping space 23A and a wire slot 24A. The connecting body 21A is suitable for providing a connection function, with one end connected to the ear-floating acoustic portion 10 and the other end connected to the positioning portion 50. The clamping space 23A is suitable for placing a user's earlobe 92, and when the outward floating earphone 1A is worn, the user's earlobe 92 is located within the clamping space 23A. According to this second preferred embodiment, the wire slot 24A is formed on the front side of the connecting body 21A. When the outward floating earphone 1A is in the wearing state, the wire slot 24A is exposed at the front side of the user, and the user can customize the color of the wires 25A in the wire slot 24A for personalized decoration, so that the wire slot 24A and the wire 25A play an additional aesthetic role.

In detail, according to this second preferred embodiment, the outward floating earphone 1A further comprises an earring unit 30A, which is embodied as a pearl, diamond, or crystal. According to another embodiment, the earring unit 30A can be embodied as any decorative element that plays a decorative role and is not limited in the present invention. The earring unit 30A is arranged on the inner surface of the connecting portion 20A. When the outward floating earphone 1A is in the wearing state, the connecting portion 20A and the user's earlobe 92 hold the earring unit 30A. The earring unit 30A can be accurately placed at the user's earlobe 92, playing a certain decorative role. In other words, when worn, the outward floating earphone 1A plays a certain role in decorating the earlobe 92 and has aesthetic appeal.

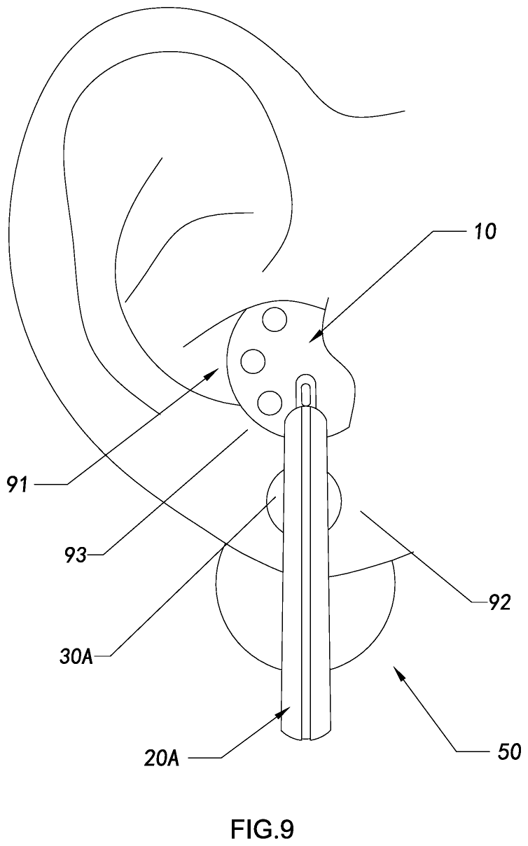

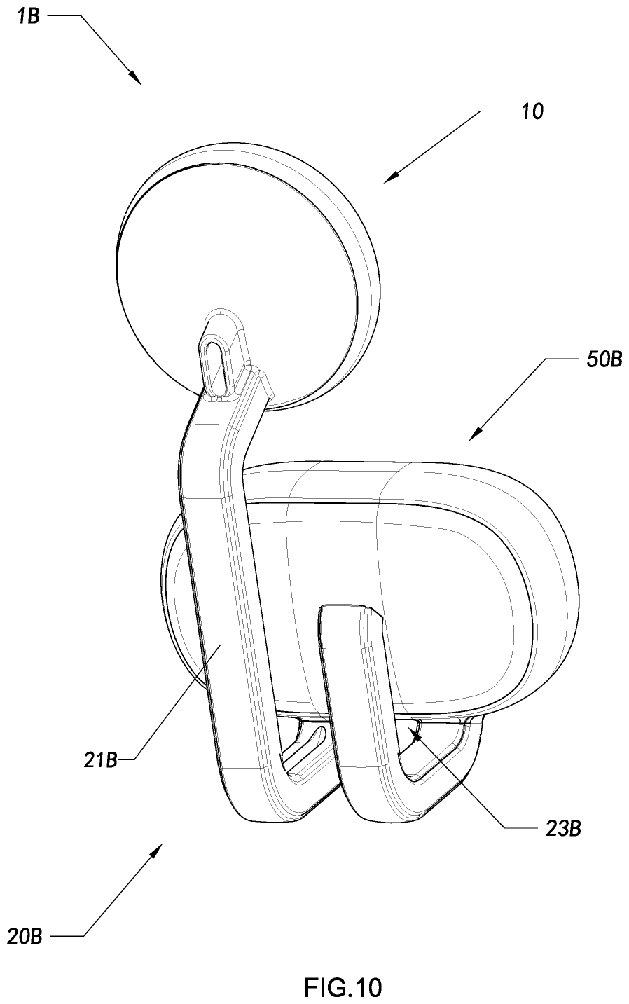

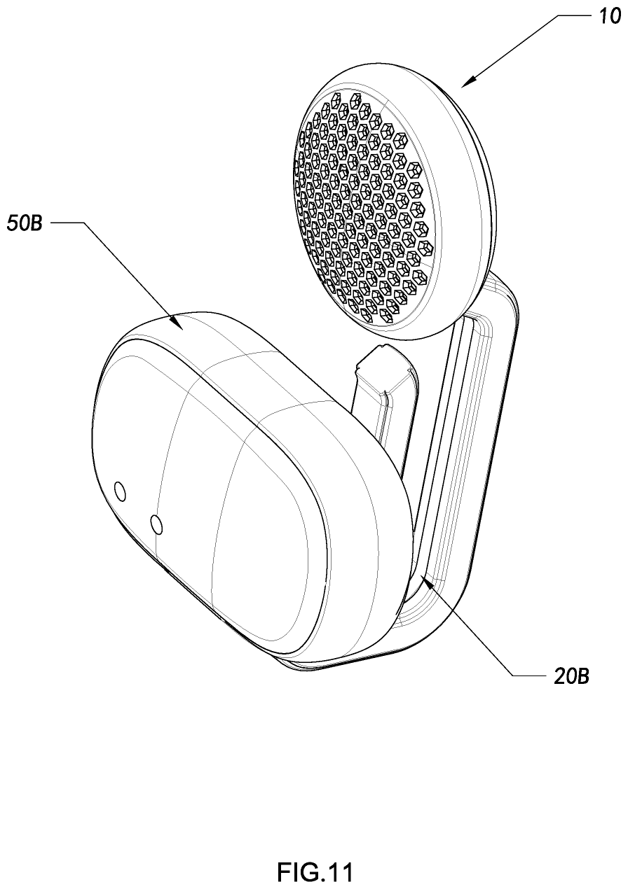

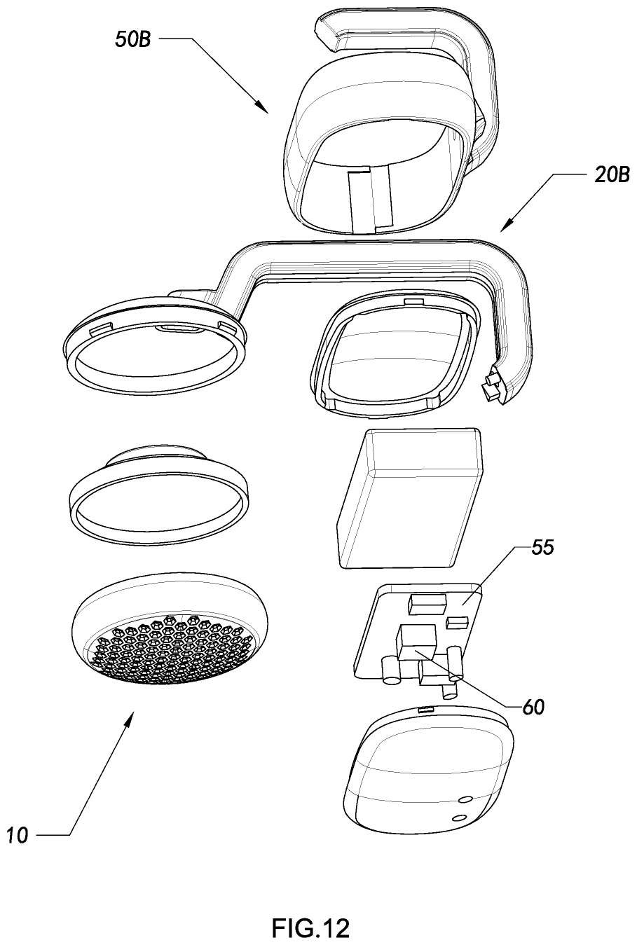

FIGS. 9 to 13 illustrates an outward floating earphone 1B according to a third preferred embodiment of the present invention. The connecting and positioning portions of the outward floating earphone 1B are different.

The outward floating earphone 1B comprises an ear-floating acoustic portion 10, a connecting portion 20B, and a positioning portion 50B. The ear-floating acoustic portion 10, the connecting portion 20B, and the positioning portion 50B are connected to each other. One end of the connecting portion 20B is connected to the ear-floating acoustic portion 10, and the other end is connected to the positioning portion 50B. When the outward floating earphone 1B is in the wearing state, the ear-floating acoustic portion 10 is located in the user's cavum conchae 91 and is connected to the antitragus 93. The connecting portion 20B is clamped to the user's earlobe 92 and extends from the front face of the user's earlobe 92 to the rear face of the earlobe 92. The positioning portion 50B is located on the back side of the user's ear. The ear-floating acoustic portion 10 has the function of outputting sound effects. The connecting portion 20B has the function of connecting and fixing. The positioning portion 50B has additional functions, such as power supply, AI intelligent interaction, etc.

Compared with the above embodiments, according to this third preferred embodiment, a connection part 20B is different, and the connection part 20B is set in a double “J” shape. When the outward floating earphone 1B is worn, the connecting portion 20B is coiled around the user's earlobe 92, and one side of the positioning portion 50B is pressed against the ear root behind the user's ear, so that the connecting portion 20B is tilted to fit the user's earlobe 92. The auxiliary positioning effect of the positioning portion 50B and the connecting portion 20B causes the outward floating earphone 1B to move outwards with the positioning portion 50B as the fulcrum, so as to bias against the position of the antitragus 93, which is equivalent to floating at the opening of the outer ear canal of the ear without embedding deeply into the outer ear canal, avoiding the formation of a closed space between the outward floating earphone 1B and the eardrum.

According to this third preferred embodiment, the connecting portion 20B comprises one or more connecting bodies 21B and has a clamping space 23B. According to this third preferred embodiment, the connecting portion 20B comprises two connecting bodies 21B, and the connecting body 21B is suitable for providing connection functions. One end of one of the connecting bodies 21B is connected to the ear-floating acoustic portion 10, and the other end of the connecting body 21B is connected to the positioning portion 50B, wherein another connecting body 21 is extended to the positioning portion 50B to provide additional clamping of the user's earlobe 92. The clamping space 23B is suitable for placing a user's earlobe 92, and when the outward floating earphone 1B is worn, the user's earlobe 92 is located within the clamping space 23B.

The outward floating earphone 1B further comprises an intelligent assistant 60, the positioning portion 50B comprises a circuit board 55, and the intelligent assistant 60 is set on the positioning portion 50B. Furthermore, the intelligent assistant 60 is installed on the circuit board 55.

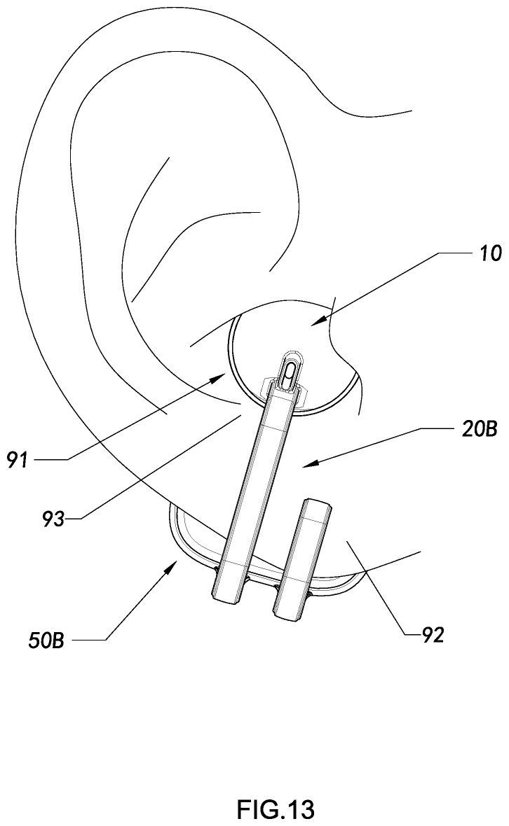

As shown in FIG. 13, the outward floating earphone 1B achieves intelligent interaction with the fan through the implementation method of the intelligent assistant 60 mentioned above. When the user issues a command to adjust the fan, remote operation interaction with the fan is achieved through the intelligent assistant 60. The purpose of executing corresponding temperature regulation according to user instructions.

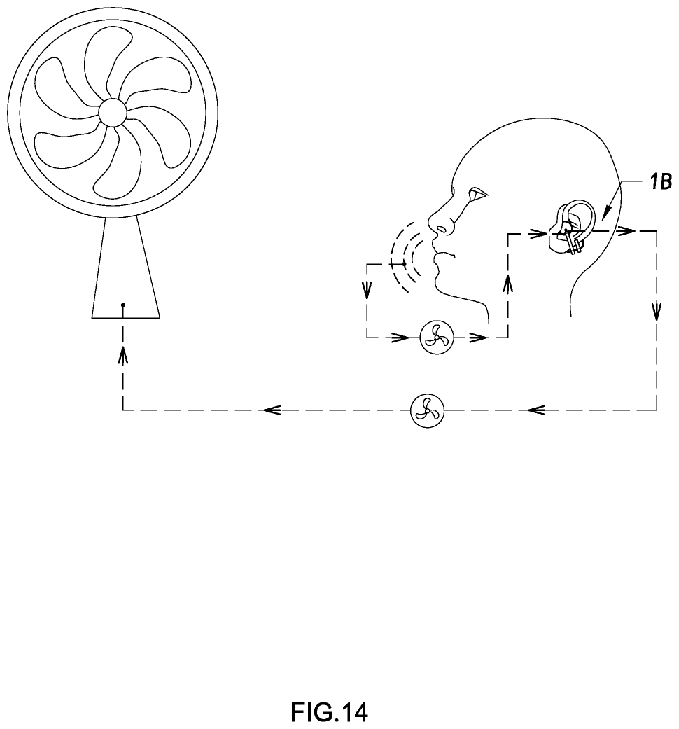

As shown in FIG. 14, an outward floating earphone 1C according to a fourth preferred embodiment of the present invention is illustrated. The outward floating earphone 1C has additional decorative functions compared to the above embodiments.

The outward floating earphone 1C comprises an ear-floating acoustic portion 10, a connecting portion 20B, and a positioning portion 50B. The ear-floating acoustic portion 10, the connecting portion 20B, and the positioning portion 50B are connected to each other. One end of the connecting portion 20B is connected to the ear-floating acoustic portion 10, and the other end is connected to the positioning portion 50B. When the outward floating earphone 1C is in the wearing state, the ear-floating acoustic portion 10 is located in the user's cavum conchae 91, the connecting portion 20B is clamped on the user's earlobe 92, extending from the front face of the user's earlobe 92 to the rear face of the earlobe 92, and the positioning portion 50B is located behind the user's ear and its inner edge is biasing against the ear root behind the ear. The ear-floating acoustic portion 10 has the function of outputting sound effects. The connecting portion 20B has the function of connecting and fixing. The positioning portion 50B can be equipped with built-in electronic components to have additional functions, such as power supply, AI intelligent interaction, etc.

According to this fourth preferred embodiment, the outward floating earphone 1C further comprises an external decoration unit 40C, which is suitable for being arranged on the front face of the connecting portion 20B. According to this fourth preferred embodiment, the external decoration unit 40C is embodied as a decorative material such as diamond. Since the material of the connecting portion 20B is preferably made of soft material, the external decoration unit 40C can be easily installed on the outer surface of the connecting portion 20B in a manufacturing process.

The outward floating earphone 1C further comprises an earring unit 30C, which is suitable for being arranged on the front face of the other connecting portion 20B. According to this fourth preferred embodiment, the earring unit 30C is embodied as an earring. When the outward floating earphone 1C is in the wearing state, the earring unit 30C is suspended from top to bottom, playing a decorative role.

According to this fourth preferred embodiment, the earring unit 30C can be embodied as a decorative pendant with different shape and appearance, such as pearl type, key type, diamond type, triangle, etc. When the outward floating earphone 1C is worn, the earring unit 30C is hung from top to bottom, playing a certain decorative role. Users can also choose a personalized earring unit 30C according to their preferences and install it on the connecting portion 20B to meet personalized fashion needs.

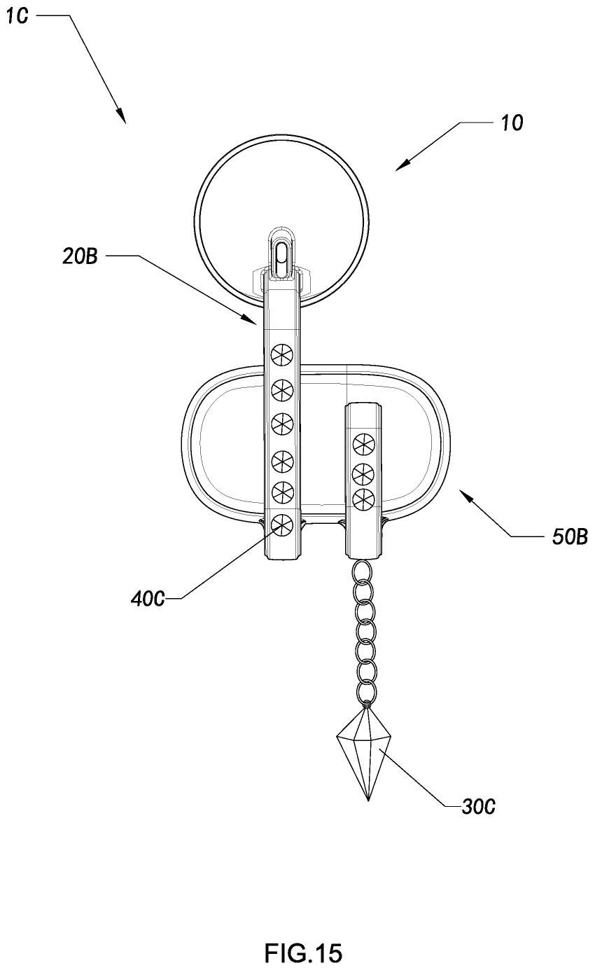

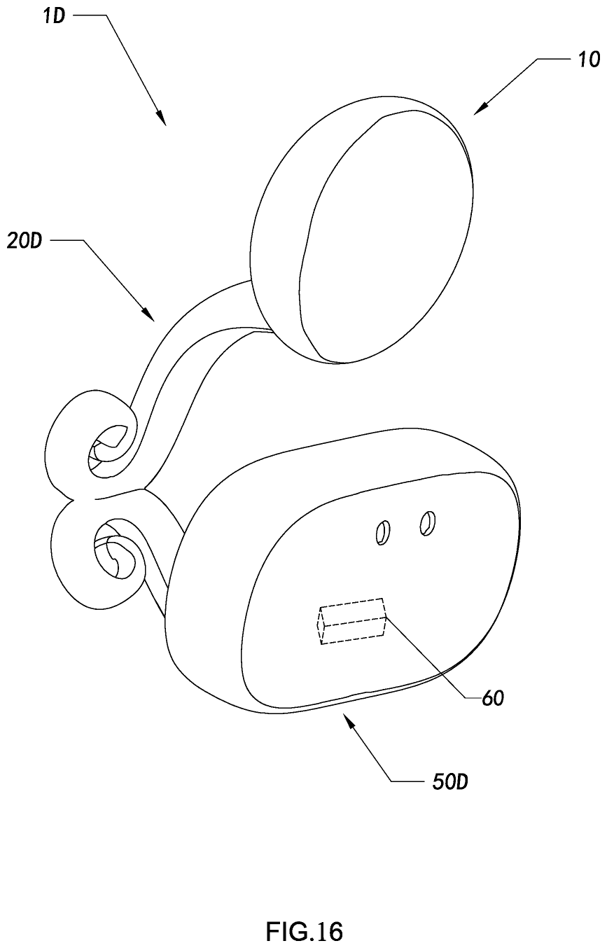

FIGS. 15 to 16 illustrate an outward floating earphone 1D according to a fifth preferred embodiment of the present invention. The shape of the connecting portion of the outward floating earphone 1D is different from the above embodiments.

The outward floating earphone 1D comprises an ear-floating acoustic portion 10, a connecting portion 20D, and a positioning portion 50D. The ear-floating acoustic portion 10, the connecting portion 20D, and the positioning portion 50D are connected to each other. One end of the connecting portion 20D is connected to the ear-floating acoustic portion 10, and the other end is connected to the positioning portion 50D. When the outward floating earphone 1C is in the wearing state, the ear-floating acoustic portion 10 is located in the user's cavum conchae 91, the connecting portion 20D is clamped on the user's earlobe 92, extending from the front face of the user's earlobe 92 to the rear face of the earlobe 92, and the positioning portion 50D is located behind the user's ear and its inner edge can abut against the ear root behind the ear. The ear-floating acoustic portion 10 has the function of outputting sound effects. The connecting portion 20D has the function of connecting and fixing. The positioning portion 50D is also equipped with built-in electronic components to have additional functions, such as power supply, AI intelligent interaction, etc. The outward floating earphone 1D further comprises an intelligent assistant 60, which is set at the positioning portion 50D, and is suitable for providing AI intelligent interaction functions.

According to this fifth preferred embodiment, the shape of the connecting portion 20D is different, and the shape of the connecting portion 20D is embodied as a “head clamp” type. The outward floating earphone 1D can customize the shape of the connecting portion 20D according to the user's preferences. When the outward floating earphone 1D is worn, the connecting portion 20D is displayed on the front face of the user, and the shape of the connecting portion 20D can be customized to show the user's sense of fashion.

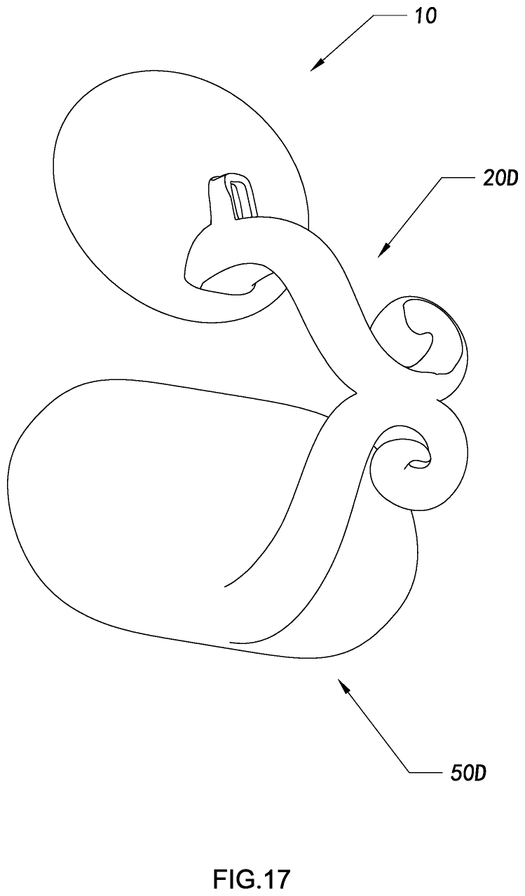

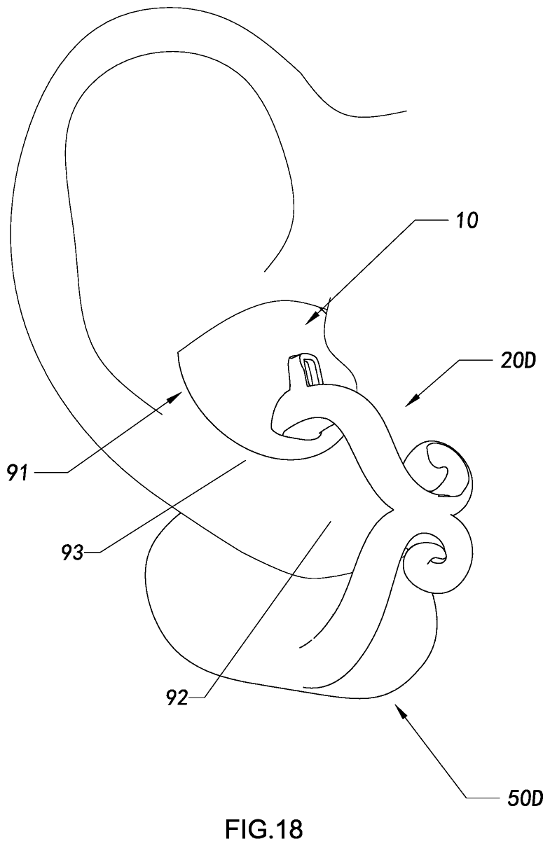

FIGS. 17 to 18 illustrate an outward floating earphone 1E according to a sixth preferred embodiment of the present invention. The shape of the functional part of the outward floating earphone 1E is different from the above embodiments, and the wearing state of the outward floating earphone 1E has changed.

The outward floating earphone 1E comprises an ear-floating acoustic portion 10, a connecting portion 20A, and a positioning portion 50E. The ear-floating acoustic portion 10, the connecting portion 20A, and the positioning portion 50E are connected to each other. One end of the connecting portion 20A is connected to the ear-floating acoustic portion 10, and the other end is connected to the positioning portion 50E. When the outward floating earphone 1E is in the wearing state, the ear-floating acoustic portion 10 is located in the user's cavum conchae 91, the connecting portion 20A is clamped on the user's ear, and the positioning portion 50E is located on the back of the user's ear. The ear-floating acoustic portion 10 has the function of outputting sound effects. The connecting portion 20A has the function of connecting and fixing. The positioning portion 50E can be equipped with built-in electronic components to have additional functions, such as power supply, AI intelligent interaction, etc. The outward floating earphone 1E further comprises an intelligent assistant 60, which is set at the positioning portion 50E, and is suitable for providing AI intelligent interaction functions.

According to this sixth preferred embodiment, the shape of the positioning portion 50E is different, and the shape of the positioning portion 50E is not limited in the present invention.

It is worth mentioning that when the outward floating earphone 1E is in the wearing state, the ear-floating acoustic portion 10 is maintained in the user's cavum conchae 91 to avoid the detachment of the outward floating earphone 1E. The connecting portion 20A spans the front side and the back side of the user's helix 94. In other words, the connecting portion 20A is extended from the front side of the user's helix 94 to the rear side of the helix 94 to realize the function of installing and fixing the ear floating headset 1E by clamping the user's helix 94. The positioning portion 50E is located on the back of the user's ear. According to this sixth preferred embodiment, the outward floating earphone 1E is clamped to the user's helix 94 by the connecting portion 20A, the ear-floating acoustic portion 10 is maintained in the user's cavum conchae 91, and the positioning portion 50E is connected to the back of the ear to achieve wearing and fixation.

Preferably, the connecting portion 20A is deformable. The ear-floating acoustic portion 10 and the positioning portion 50E are made of rigid or deformable and ductile materials, so that the relative positions of the ear-floating acoustic portion 10 and the positioning portion 50E can be adjusted slightly when subjected to external forces, so as to adjust the size of the space formed between the connecting portion 20A, the ear-floating acoustic portion 10, and the positioning portion 50E, so as to facilitate adaptation to the ears of different users. For example, the connecting portion 20A is made of copper, and the part connecting the ear-floating acoustic portion 10 and the positioning portion 50E to the connecting portion 20A is also made of copper, so as to maintain predetermined ductility while maintaining aesthetics. In addition, ductile materials can also be silver, stainless steel, or precious metals.

It is worth mentioning that through the wearing method of the outward floating earphone 1E, the shape of the connecting portion 20A can be customized to achieve a decorative effect on the user's ear across the user's helix 94. In other words, by fixing the connecting portion 20A horizontally, the decorative purpose of the user's helix 94 can be increased to a certain extent, highlighting the user's sense of fashion and meeting their personalized needs.

According to this sixth preferred embodiment, the outward floating earphone 1E is clamped on the front and rear sides of the user's ear, and is clamped and connected to the helix 94 through the connecting portion 20A and the positioning portion 50E is connected to the back of the ear, so that the outward floating earphone 1E has a tendency to drive the ear-floating acoustic portion 10 to move outward with respect to the positioning portion 50B as the fulcrum, Thus, it is floating at the opening of the outer ear canal of the ear without embedding deeply into the outer ear canal, avoiding the formation of a closed space between the outward floating earphone 1E and the eardrum of the ear.

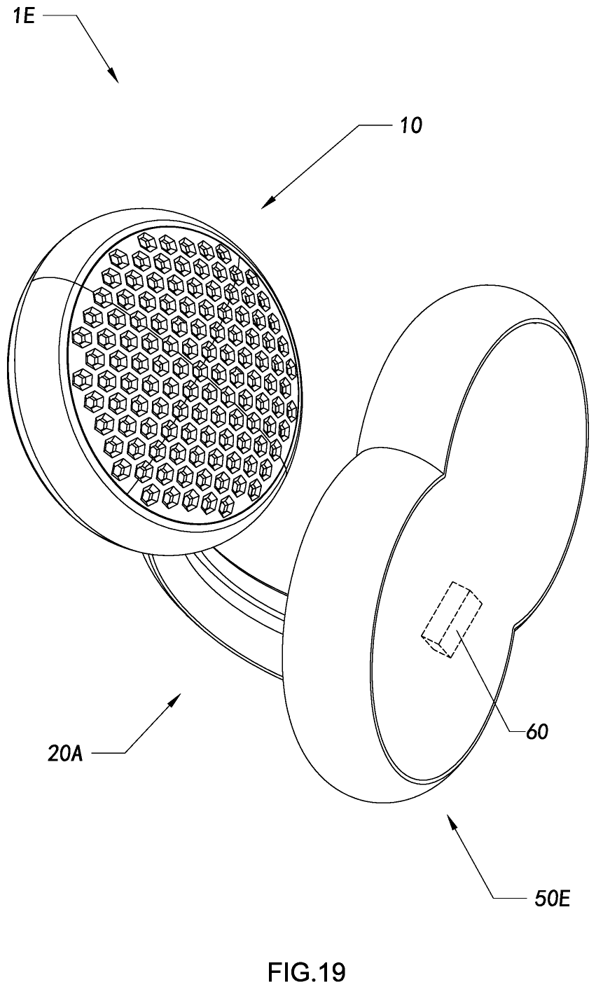

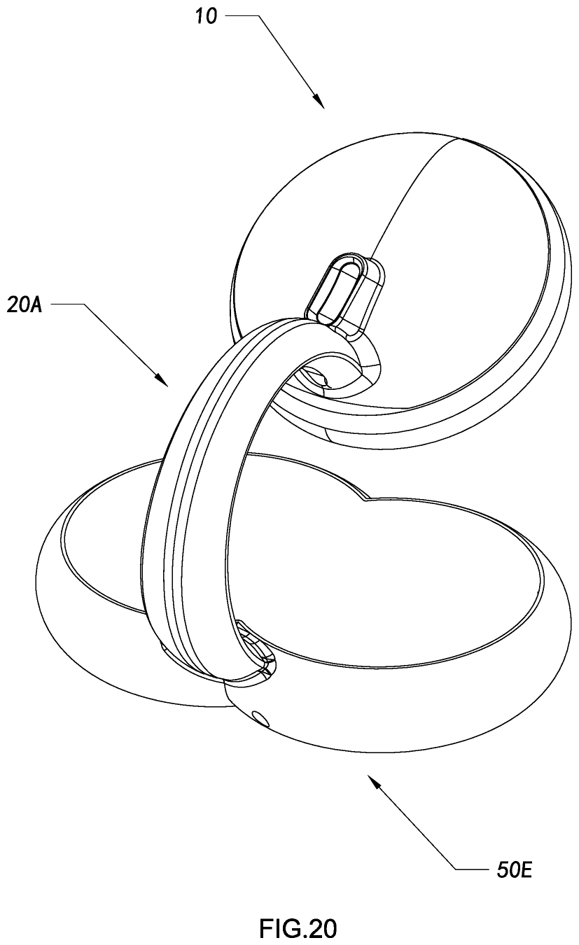

FIGS. 19 to 20 illustrate an outward floating earphone 1F according to a seventh preferred embodiment of the present invention. The shape of the functional part of the outward floating earphone 1F has changed compared to the above embodiments, and the wearing state of the outward floating earphone 1F has changed.

The outward floating earphone 1F comprises an ear-floating acoustic portion 10, a connecting portion 20A, and a positioning portion 50F. The ear-floating acoustic portion 10, the connecting portion 20A, and the positioning portion 50F are connected to each other. One end of the connecting portion 20A is connected to the ear-floating acoustic portion 10. and the other end is connected to the positioning portion 50F. When the outward floating earphone 1E is worn, the ear-floating acoustic portion 10 is located in the user's cavum conchae 91, the connecting portion 20A is clamped on the user's auricle, extending from the front face of the user's helix 94 to the rear face of the helix 94, and the positioning portion 50F is located on the back side of the user's ear. The ear-floating acoustic portion 10 has the function of outputting sound effects. The connecting portion 20A has the function of connecting and fixing. The positioning portion 50E can be built-in with electronic components to have additional functions, such as power supply, AI intelligent interaction, etc. The outward floating earphone 1F further comprises an intelligent assistant 60, which is set at the positioning portion 50F, and is suitable for providing AI intelligent interaction functions.

According to this seventh preferred embodiment, the shape of the positioning portion 50F is similar to an ellipse and does not have the shape of two semicircles connecting the cross-section of the positioning portion 50E in the sixth preferred embodiment mentioned above. Electronic components can be arranged side by side, and the positioning portion 50F can be arranged in layers along the thickness direction. It can be understood that the shape of the positioning portion 50F is not limited in the present invention. Due to the clamping and fixing manner of the outward floating earphone 1F, the positioning portion 50F is always located at the back of the user's ear. Due to the functional separation between the positioning portion 50F and the floating ear sounding unit 10, the electronic components of the positioning portion 50F located on the back of the user's ear can select larger functional components in the manufacturing process. For example, a power supply with a larger capacity is used to increase the power range of the outward floating earphone 1F, so as to achieve a longer standby and use time, and to prolong the service life of the outward floating earphone 1F, and to indirectly reduce the usage cost of the outward floating earphone 1F, so as to gain favorable market prospects and promote it.

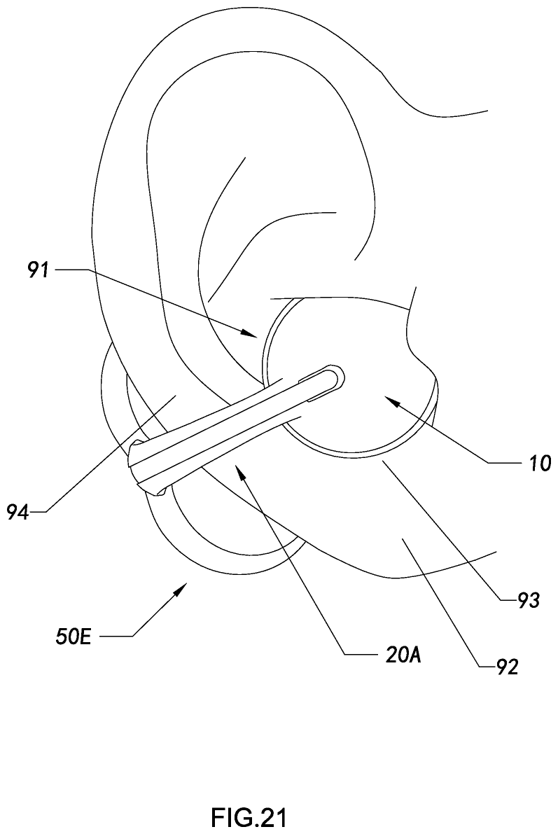

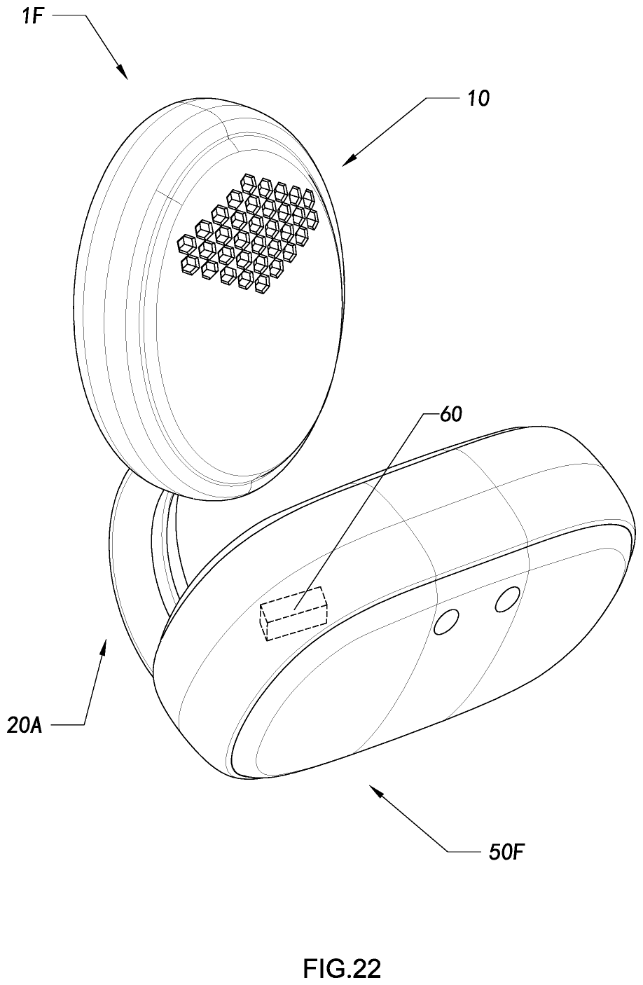

As shown in FIGS. 21 to 22, an outward floating earphone 1G according to an eighth preferred embodiment of the present invention, is illustrated. The shape of the functional and connecting portions of the outward floating earphone 1G has changed compared to the above embodiments, and the wearing state of the outward floating earphone 1G has changed.

The outward floating earphone 1G comprises an ear-floating acoustic portion 10, a connecting portion 20G, and a positioning portion 50G. The ear-floating acoustic portion 10, the connecting portion 20G, and the positioning portion 50G are connected to each other. One end of the connecting portion 20G is connected to the ear-floating acoustic portion 10, and the other end is connected to the positioning portion 50G. When the outward floating earphone 1G is worn for the user to listen to sound effects, the car-floating acoustic portion 10 is located in the user's cavum conchae 91, the connecting portion 20G is located between the user's antitragus 93 and earlobe 92, and the positioning portion 50G is located at the user's earlobe 92. The car-floating acoustic portion 10 has the function of outputting sound effects. The connecting portion 20G has the function of connecting. The positioning portion 50G can be equipped with built-in electronic components to have additional functions, such as power supply, AI intelligent interaction, etc. The outward floating earphone 1G further comprises an intelligent assistant 60, which is set at the positioning portion 50G, and is suitable for providing AI intelligent interaction functions.

The outward floating earphone 1G further comprises a hook holding portion 70G which is integrally connected to the positioning portion 50G. In other words, the hook holding part 70G is extended as a part of the positioning portion 50G. The hook holding portion 70G can further provide a clamping and fixing function when wearing the outward floating earphone 1G. When the outward floating earphone 1G is worn, the hook holding portion 70G is suitable for being fixed to the car hole 95 on the user's earlobe 92. In other words, the upper edge of the outward floating earphone 1G is limited and clamped by the antitragus 93, and the lower end is completely fixed through the ear hole 95.

It is worth mentioning that the outward floating earphone 1G has two wearing states. When a user wants to use the outward floating earphone 1G to enjoy music, the user places the car-floating acoustic portion 10 into the cavum conchae 91, and the other end portion is attached to the user's earlobe 92. When the user does not use the 1G outward floating earphone, the user can also wear the outward floating earphone 1G to play a certain decorative role. In detail, at this time, the outward floating earphone 1G is hung upside down with the hook holding portion 70G penetrating through the user's car hole 95. From an external perspective, the outward floating earphone 1G is hung upside down at the user's earlobe 92. From an external perspective, the positioning portion 50, the connecting portion 20, and the car-floating acoustic portion 10 tend to be integrated. The outward floating earphone 1G is similar to a pendant hanging at the user's earlobe 92, serving as a decoration for the user's earlobe 92, and has a certain aesthetic value, so as to meet the personalized fashion needs of the user.

It is worth mentioning that the outward floating earphone 1G also has another way of being fixed to the user's ear. When the outward floating earphone 1G is in a second wearing state, the hook holding portion 70G winds from the front side of the user's earlobe 92 to the back side. The hook holding portion 70G is implemented in a curved hook shape according to the embodiment, and the material of the hook holding portion 70G can optionally be made of a material with strong ductility. When the outward floating earphone 1G is in the second wearing state, the hook holding portion 70G is suitable for being clamped and fixed in the user's cavum conchae 91 through controllable clamping by the user. In other words, the user can adapt to the wearing situation of different age groups through the hook holding portion 70G. By wearing and fixing the hook holding portion 70G, the outward floating earphone 1G is prevented from falling off and losing during the wearing process.

In addition, the outward floating earphone 1G can also be used for decoration. In detail, the hook holding portion 70G is used to hook onto the user's ear, enabling the outward floating earphone 1G to be hooked onto the user's ear as a whole, forming a decorative effect similar to traditional earrings. Preferably, the holding part 70G can be hooked onto the user's earlobe 92, and the ear-floating acoustic portion 10 is located on the bottom side in a suspended state.

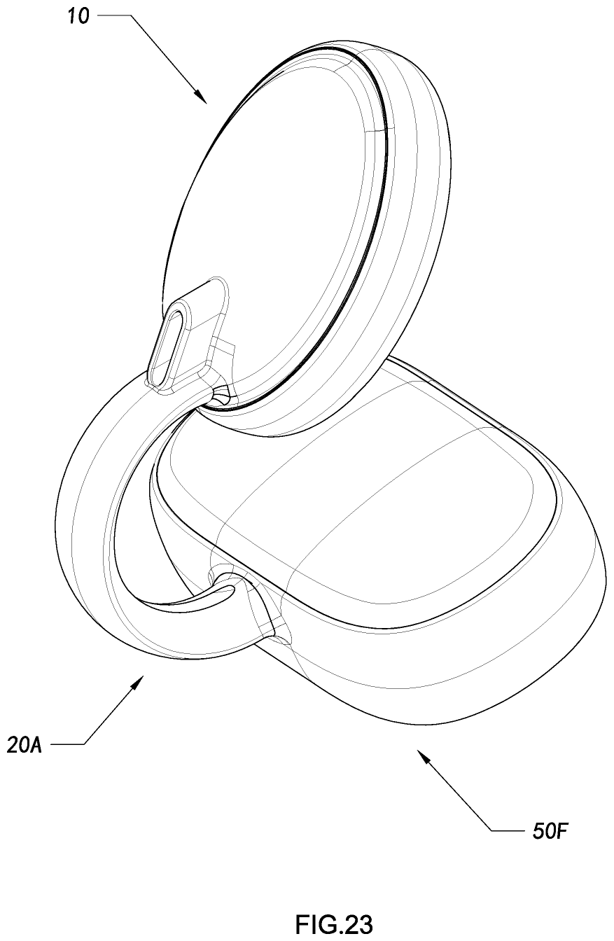

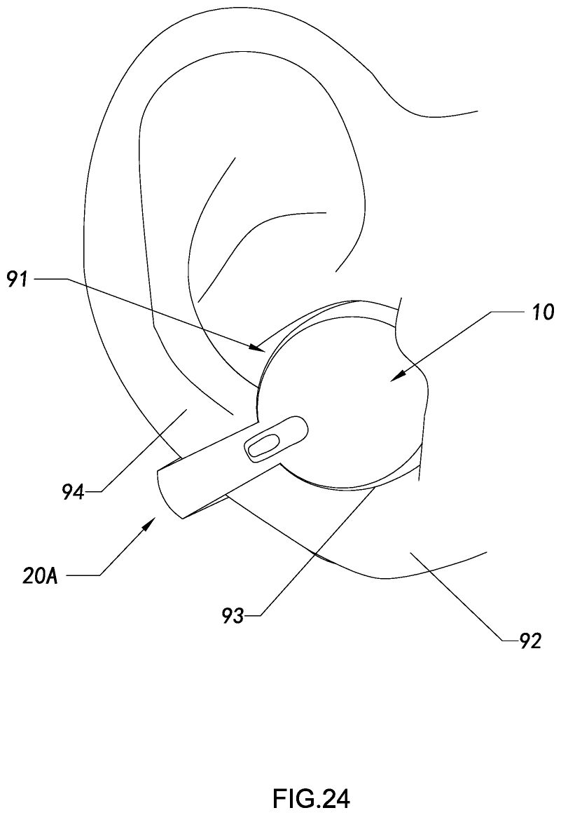

FIGS. 23 to 24 illustrate an outward floating earphone 1H according to a ninth embodiment of the present invention. The main difference between the outward floating earphone 1H and the above embodiments is the structural deformation of the functional part.

The outward floating earphone 1H comprises an ear-floating acoustic portion 10, a connecting portion 20G, and a positioning portion 50H. The ear-floating acoustic portion 10, the connecting portion 20G, and the positioning portion 50H are connected to each other. One end of the connecting portion 20G is connected to the ear-floating acoustic portion 10, and the other end is connected to the positioning portion 50H. When the outward floating earphone 1H is worn, the car-floating acoustic portion 10 is located in the user's cavum conchae 91, the connecting portion 20G is located between the user's antitragus 93 and the car lobe 92, and the positioning portion 50H is located at the user's car lobe 92. The car-floating acoustic portion 10 has the function of outputting sound effects. The connecting portion 20G has the function of connecting. The positioning portion 50H is equipped with built-in electronic components and additional functions, such as power supply, AI intelligent interaction, etc. The outward floating earphone 1H further comprises an intelligent assistant 60, which is set at the positioning portion 50H, and is suitable for providing AI intelligent interaction functions.

The outward floating earphone 1H also comprises a hook holding portion 70H which is implemented to have a curved hook shape with certain ductility. The hook holding portion 70H is more slender compared to the hook holding portion 70G of the above embodiment, and the hook holding portion 70H is used to match with the positioning portion 50H with a longer length. The positioning portion 50H is implemented tp have a rectangular shape in this embodiment, and the front surface of the positioning part 50H can be decorated externally. When the outward floating earphone 1H is in a wearing state, the positioning portion 50H is at the front side and is exposed externally. By forming an external pattern of the positioning portion 50H, it plays a certain decorative role. The positioning portion 50H is always located on the front side of the hook holding part 70H to maintain the upper end of the hook holding part 70H to align with the upper end of the positioning portion 50H, so as to ensure that the outward floating earphone 1H does not fall off during the wearing process, the hook holding portion 70H and the positioning portion 50H work together to clamp and fix the outward floating earphone 1H, so as to make it more stable when being worn.

Moreover, the outward floating earphone 1H can also be used for decoration. In detail, the hook holding portion 70H is used to hook onto the user's car, so as to enable the outward floating earphone 1H to be hooked onto the user's car as a whole, so as to form a decorative effect similar to traditional earrings. Preferably, the holding part 70H can be hooked onto the user's earlobe 92, and the ear-floating acoustic portion 10 is located on the bottom side in a suspended state.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention comprises all modifications encompassed within the spirit and scope of the following claims.

What is claimed is:

1. An outward floating earphone, comprising:
an ear-floating acoustic portion for being placed in a cavum conchae of a user's ear to produce sound effect;
a connecting portion; and
a positioning portion, wherein said ear-floating acoustic portion and said positioning portion are respectively connected to two opposite ends of said connecting portion, wherein said connecting portion is bent and extended to make said positioning portion be suitable for being located at a back of the user's ear, so as to make said ear-floating acoustic portion suitable for floating at a front end of the cavum conchae through fixing effect of said positioning portion and said connecting portion.

2. The outward floating earphone as recited in claim 1, wherein when said outward floating earphone is in a wearing state, said connecting portion is clamped on the user's helix, and said positioning portion is located on a rear side of the user's helix.

3. The outward floating earphone as recited in claim 1, wherein when said outward floating earphone is in a wearing state, said connecting portion is clamped on the user's earlobe, and said positioning portion is located on a back side of the user's earlobe.

4. The outward floating earphone as recited in claim 1, wherein when said outward floating earphone is in a wearing state, said connecting portion is clamped on the user's earlobe, and said positioning portion is biasing against an ear root at the back of the user's ear.

5. The outward floating earphone as recited in claim 1, further comprising a hook holding portion connected to said positioning portion for hooking to the user's ear, so that said outward floating earphone serves as an ornament when not in operation for producing the sound effect.

6. The outward floating earphone as recited in any claim 1, further comprising at least one external decoration unit which is arranged on at least a part of surfaces of said ear-floating acoustic portion, said positioning portion, and said connecting portion.

7. The outward floating earphone as recited in claim 1, further comprising an earring unit, wherein said earring unit is a pendant arranged at one of said connecting portion and said positioning portion.

8. The outward floating earphone as recited in claim 1, further comprising an intelligent assistant disposed inside said outward floating earphone, wherein said intelligent assistant comprises:
an input algorithm for receiving information;
a processing algorithm for processing information from a network; and
an output algorithm for outputting information to control the outward floating earphone to produce the sound effect to the user.

9. The outward floating earphone as recited in claim 8, wherein said input algorithm comprises an sensing assembly and a voice inquiry module, wherein said sensing assembly monitors user data parameters and actively inquries the user for the user's need through said voice inquiry module.

10. The outward floating earphone as recited in claim 9, wherein said input algorithm comprises a voice receiving module adapted to passively receive information transmitted from a user to said outward floating earphone.

11. The outward floating earphone as recited in claim 8, wherein said processing algorithm comprises a processing module, a search module, a comparison module, and a confirmation module, wherein said processing module, said search module, said comparison module, and said confirmation module are arranged to operate in sequence, so as to filter and process the information provided by said input algorithm online.

12. The outward floating earphone as recited in claim 8, wherein said output algorithm comprises a transmission module adapted to transmit processed information to an external intelligent device.

13. The outward floating earphone as recited in claim 8, wherein said output algorithm comprises a sound output module adapted to transmit processed information to a user through said outward floating earphone.

14. A method of implementing intelligent voice interaction by an earphone, comprising the following steps:
(A) incorporating an intelligent assistant into an earphone for intelligent interaction;
(B) receiving a voice command by a microphone unit;
(C) transmitting signals related to the voice command to said intelligent assistant; and
(D) providing feedback to a user in such a manner that said intelligent assistant controls said earphone to produce sound effect.

15. The method as recited in claim 14, wherein said intelligent assistant accesses real-time information on the network and emits sound through said earphone to provide feedback to the user.

16. The method as recited in claim 15, wherein said intelligent assistant searches for answer information corresponding to the voice command on the network and produces the sound effect through said earphone to provide feedback to the user.

17. The method as recited in claim 15, wherein said intelligent assistant performs online shopping based on the corresponding voice command, and generate the sound effect through said earphone to feedback to the user.

18. The method as recited in claim 15, wherein said intelligent assistant control said earphone to produce the sound effect related to multimedia information obtained from the network based on the corresponding voice command, so as to feedback to the user.

19. The method as recited in claim 15, wherein said intelligent assistant makes phone calls, sends emails, provides peripheral travel suggestions to users, or controls operation of an intelligent device based on the corresponding voice command, wherein the intelligent device is a home or office device.

20. The method as recited in claim 14, wherein said earphone is an outward floating earphone comprising:
an ear-floating acoustic portion for being placed in a cavum conchae of a user's ear to produce sound effect;
a connecting portion; and
a positioning portion, wherein said ear-floating acoustic portion and said positioning portion are respectively connected to two opposite ends of said connecting portion, wherein said connecting portion is bent and extended to make said positioning portion be suitable for being located at a back of the user's ear, so as to make said ear-floating acoustic portion suitable for floating at a front end of the cavum conchae through fixing effect of said positioning portion and said connecting portion.
